(19) United States
(12) Patent Application Publication
(10) Pub. No.: US 2022/0036222 A1
(43) Pub. Date: Feb. 3, 2022

(54) Distributed algorithm to find reliable, significant and relevant patterns in large data sets

(71) Applicant: Innominds Inc., San Jose, CA (US)

(72) Inventors: Arun Kumar Parayatham, Hyderabad (IN); Ravi Kumar Meduri, Secunderabad (IN)

(73) Assignee: Innominds Inc., San Jose, CA (US)

(21) Appl. No.: 17/464,891

(22) Filed: Sep. 2, 2021

Related U.S. Application Data
(63) Continuation of application No. 15/166,233, filed on May 26, 2016, now abandoned.

(51) Int. Cl. G06N 5/04; G06N 7/00; G06F 16/2457; G06F 16/2458; G06N 5/02; G06N 20/00

(52) U.S. Cl. CPC G06N 5/047; G06N 7/005; G06N 20/00; G06F 16/2465; G06N 5/02; G06F 16/24578

(57) ABSTRACT

System pre-processes and computes class distribution of decision attribute and statistics for discretization of continuous attributes through use of compute buckets. System computes the variability of each of the attributes and considers only the non-zero variability attributes. System computes the discernibility strength of each attribute. The software system generates size 1 patterns using compute bucket and calculates if each pattern of size 1 is a reliable pattern for any class. The system calculates if reliable pattern of size 1 is a significant pattern for any class. The system generates size k patterns from size k−1 patterns checking for significance of size k patterns and refinability. The system readjusts pattern statistics for only significant patterns for size k−1 patterns. The system computes a cumulative coverage of the sorted relevant patterns of up to size k by finding out the union of records of that particular class.

### CROSS-REFERENCE TO RELATED APPLICATION

This application claims priority from and is a continuation of U.S. patent application Ser. No. 15/166,233, filed on May 26, 2016 and is incorporated herein by reference in its entirety

### BACKGROUND OF THE INVENTION

The purpose of the invention is to build a system for automatic analysis of large quantities of data to extract using a distributed algorithm, all reliable, significant and relevant patterns that occurred in the data for each class of the decision attribute. The invention is in the distributed algorithm for reduction of search space to do the pattern extraction in an efficient manner while not losing any valid pattern. The system does not use any heuristic to do this and instead evaluates each pattern for reliability, refinability (significantly improving) and relevance through statistical tests. An efficient distributed method is provided that extracts and refines patterns from size 1 up to size N by constantly referencing the record set and performing the tests. The system also provides an option to select top k patterns and how much of a particular class is covered by those top k patterns. The system also provides an optimum number of reliable patterns to cover almost all records (except the outlier instances) for each class. These patterns can then be seen as a kind of summary of the dataset.

Studying historical data and finding patterns has been in existence for a long time. Most of today's data mining or pattern matching techniques in classification or estimation use historical data to train a model for patterns in that data. Due to the computational intensity, these techniques use a range of greedy algorithms such as gradient descent, to identify a pattern and optimize it for a given accuracy (often called as loss function which is minimized).

However, these techniques work well when the data is representative of the population, the variance is well explained and pattern regions are smooth.

For example, contrast the scatter plots for FIG. 1 and FIG. 2. Another data set with a two-way scatter plot is shown in FIG. 3.

The scatter plots reveal how existing techniques fail to work with rough data sets, where a sharp classification or estimation is not possible. In such cases, most techniques cause the error by working on the entire range of values of the attribute as one unit and using a defined loss function to minimize the error.

Even techniques such as decision trees breakdown the range of values of an attribute into intervals and work with the attribute splitting the data. But decision trees do the tree building by considering the full range of attribute values and then prioritizing them using information gain of the attribute. This technique then fails to address which attributes are important and the select values of the attribute that are important in different regions of the data.

As against, these techniques, current pattern searching method does not consider all the values of the attribute in all the regions in the same way. Instead, it tries to identify on the basis of probability, clusters or regions that can densely classify or estimate.

A comparison of the existing techniques with the current pattern searching method is provided below:

| Technique | Description | Advantages | Limitations |
|---|---|---|---|
| Parametric | Assume a host of | Work well with | Struggle |
| methods e.g. | parameters | continuous and | when the |
| linear | including | discrete data | assumptions |
| regression, | distributions, | Open box | are not met |
| logistic | exogeniety, | approach giving | which |
| regression | linearity, | attribute | typically is |
| and variants | homoscedasticity | importance, | the case |
| | etc. | direction and | with most |
| | | magnitude of | real world |
| | | effect | data |
| Non- | Use hyper planes | Provide deep | Work only |
| parametric | or hidden layers | learning | with numeric |
| Assumption | to compute a | capabilities and | data. |
| free hidden | linear or non- | need no | Hidden |
| methods e.g. | linear | assumptions on | methods that |
| ANN, SVM etc. | transformation | distributions, | are |
| | of the attribute | co-linearity, | difficult to |
| | space | linearity etc. | understand |
| | | | and explain |
| Assumption | Use decision | Easy to | Uses a |
| free open | splits at nodes | understand and | heuristic or |
| methods e.g. | to classify or | explain. Can | a greedy |
| Decision | estimate. Do not | handle numeric | algorithm |
| Trees | assume any | and categorical | that |
| | distributions | data but | converges |
| | | struggles with | the search |
| | | continuous data | space |
| Claimed | Uses | Easy to | Computationally |
| pattern | combinations of | understand and | intensive |
| searching | attribute spaces | explain. Can | despite |
| method | and an optimized | handle numeric | optimization |
| | search method | and categorical | |
| | for the | data but | |
| | significant | struggles with | |
| | reliable | continuous data | |
| | patterns | | |

FIG. 4 represents dense regions or clusters in a fraud dataset.

Identification of such clusters requires enumerating all probable patterns in the dataset considering all or some of the attributes and their values.

The complexity can be understood from the fact that, in a dataset with m attributes and n as average attribute cardinality, the number of patterns that need to be evaluated goes up to (1+n)^{m}−1. So for a dataset with 30 attributes and average cardinality of 10, the number of patterns would be 31¹⁰˜8×10¹⁴ or 800 trillion. This requires not only an efficient approach but to quickly and accurately reduce the number of patterns to be evaluated through identification of dense regions and focusing on such regions first and then going into the sparse regions based on the usefulness and validity of classifying or estimating error. However, this approach when used on large datasets has computational complexity that implies that it may not be possible to achieve this on a single memory system. But fortunately, the process of generating, evaluating and ranking the patterns can each be done in parallel with different computing buckets taking care of their assigned partitions of data. A distributed approach of parallelizing the computation exploits this to process such large data sets. Also, this approach can leverage the storage or memory available through the disk to read and write data.

### SUMMARY OF THE INVENTION

The software system processes through the following high level steps in order to extract reliable, significant and relevant patterns in a large dataset using a distributed algorithm across multiple systems.

The system pre-processes and computes class distribution of decision attribute and statistics for discretization of continuous attributes through use of compute buckets. The system then computes the minimum class probability and minimum class frequency such that patterns should be reliable and significant based on user input and the system keeps these in shared memory. The software system discretizes the continuous attributes. The system computes the variability of each attribute and removes attributes of zero variability. The system computes the discernibility strength of each attribute. The system sorts the attributes based on descending order based on discernibility strength.

The software system makes row based partitions of the data based on the number of computing buckets available and generates size 1 patterns from each record using compute bucket. The system sorts the size 1 patterns obtained from all the records and sends them to different computing buckets so that each pattern is processed at one available computing bucket. The system computes the pattern statistics for the size 1 patterns and calculates if each pattern of size 1 is a reliable pattern for any class based on the minimum class frequency and probability through the computing bucket. The system calculates if reliable pattern of size 1 is a significant pattern for any class if class probability is higher than class probability of that class in said dataset. The system calculates if patterns of size 1 is a refinable pattern for any class where at least one class has a required minimum frequency and does not have 1 as the upper end of the estimated population probability confidence interval through the computing bucket. The system calculates required minimum frequency and required minimum probability for a size 2 refined pattern to be significant. The system then partitions the refinable patterns and sends them to a computing bucket along with the required statistics for the pattern.

The system through the computing buckets generates size k patterns from size k−1 patterns checking for significance of size k patterns and refinability and computing the required minimum frequency and probability for its further refined size k+1 patterns to be significant. The system readjusts record set and pattern statistics for significant super patterns for up to size k−1. The system computes the relevancy of each significant pattern and removing patterns if not relevant. The system sorts all significant relevant patterns based on high pattern class probability, high frequency and low pattern size. The system computes a cumulative coverage of the sorted relevant patterns of up to size k by finding out the union of records of that particular class.

### BRIEF DESCRIPTION OF THE DRAWINGS

FIG. 1 depicts a graph demarcating a sharp classification, which is possible with the data set.

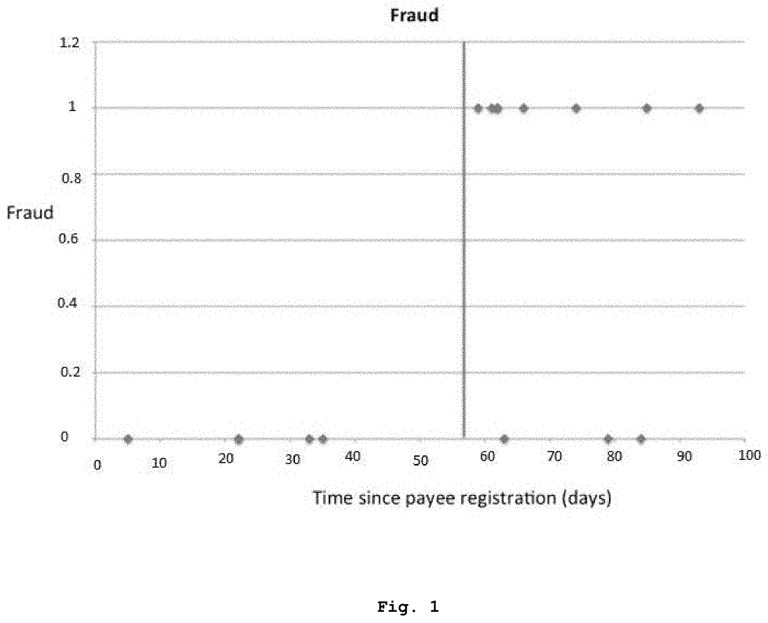

FIG. 2 depicts a graph demarcating a sharp classification, which results in errors in the data set.

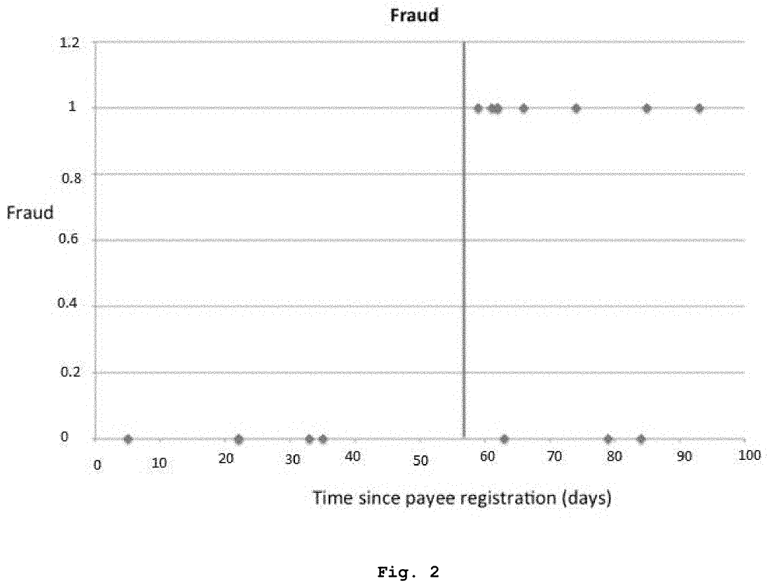

FIG. 3 depicts a rough set where sharp classifications are not possible with elapsed time since the creation of the task (days) as X Axis; Y Axis: time remaining to complete a task (days); 1—Task updated in a day; 0—Task not updated in a day.

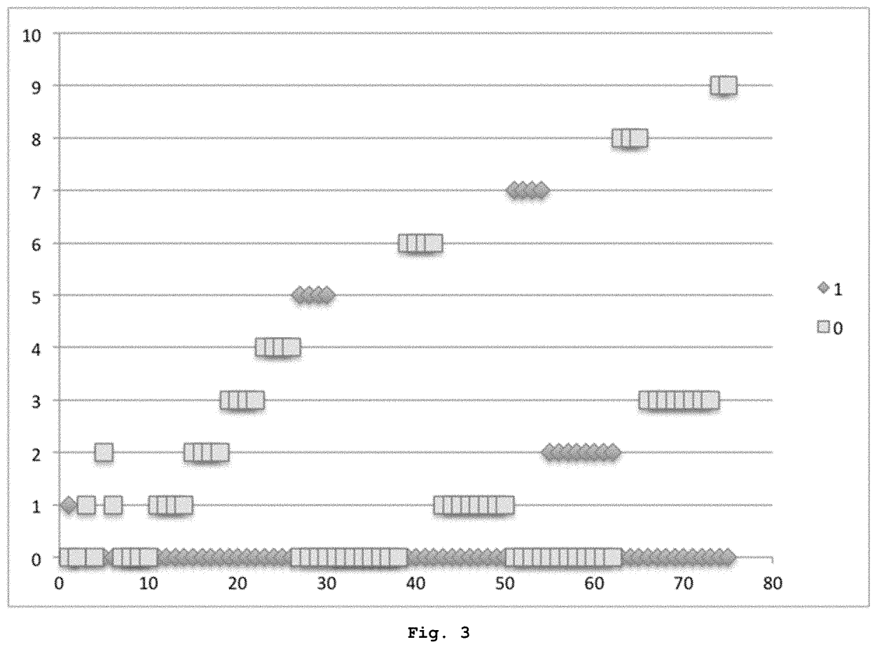

FIG. 4 depicts an identification of dense regions or clusters, which have different behavior.

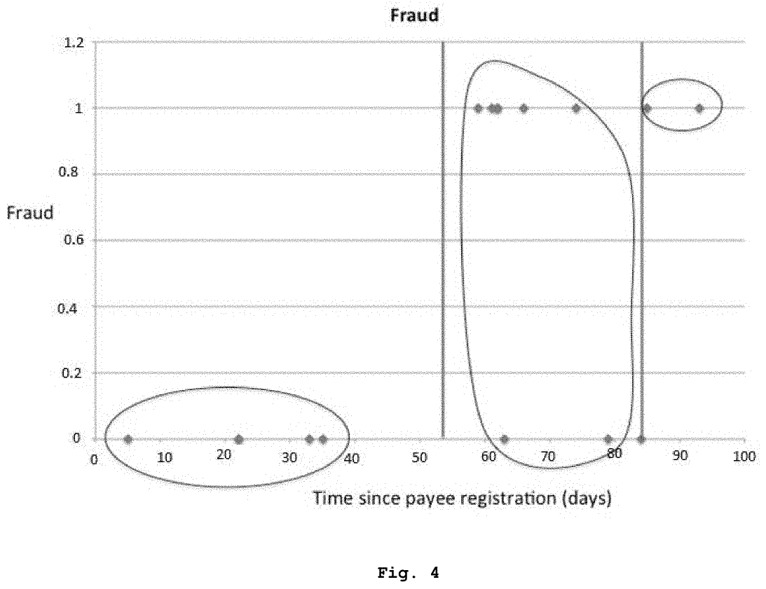

FIG. 5 shows the high level process for discretizing the dataset.

FIG. 6 shows the high level process for the discretizing the record set and finding the refinable patterns for size 1.

FIG. 7 shows the high level process for finding the size k reliable significant patterns.

FIG. 8 shows a detailed parallel processing for computing class distribution and statistics of continuous attributes.

FIG. 9 show a detailed parallel processing for finding the refinable patterns for size 1.

FIG. 10 shows the detailed parallel processing for computing size k significant and refinable patterns from size k−1 refinable patterns.

FIG. 11 shows parallel processing for computing reliable, relevant and significant patterns.

FIG. 12 depicts a high level computer implementation diagram for processing the data for finding patterns.

### DETAILED DESCRIPTION

### Definitions

Let DS be dataset with attribute set A={C₁, C₂, . . . , Cₙ, D} where C₁, C₂, . . . , Cₙ are conditional attributes and D is a decision attribute. Let {cⱼᵢ} be the range of Conditional attribute Cⱼ. Let {dₗ} be the range of D where l=1 to m where m is the number of classes. For a value i of l, a record in a dataset is called a class dᵢ record (if its decision attribute value is dᵢ. Let P=(P1, P2, . . . , Pk) is a sub sequence of (1, 2, 3, . . . , n) and P={C_{P1}, C_{P2}, . . . , C_{Pk}} be a non-empty conditional attribute subset of A. The discernibility of an attribute is the weighted average positive difference (lift) between the class probability at a particular value of the attribute compared to the class probability across all values. This is done for all classes with improved probabilities. The weights are equal to the frequency of the attribute value.

A group of data records having same values for a subset of conditional attributes P={C_{P1}, C_{P2}, . . . , C_{Pk}} of the data is called a pattern.

Mathematically, the set of all records satisfying certain conditions C_{Pi}(record)=cₚᵢₗ, where cₚᵢₗ is a fixed value in the range of Conditional attribute Cₚᵢ form a pattern ((C_{P1}, C_{P2}, . . . , Cₚₖ), (cₚ₁ₗ, cₚ₂ₗ, . . . , cₚₖₗ)).

The size of the pattern is the number of attributes involved in its definition. The pattern size can be one to the number of attributes in the dataset.

Frequency of a pattern in a dataset is the number of records satisfying that pattern's conditions.

A class is majority in a pattern if more records belong to that class than other classes.

If class A is existing in a pattern, that pattern is a class pattern of the class A.

The class probability in the pattern is the estimated lower bound of the confidence interval of the population probability at the given confidence levels from the class pattern for that class.

A class pattern is called a reliable pattern for class dₗ if it has enough frequency, so that the estimated population class probability is more than a given minimum probability. The minimum probability is typically set as an input to the system. This is checked with comparison of estimated minimum value of confidence interval of the population for class dₗ with confidence c with minimum probability x expected in the population. Thus class frequency to be of minimum n which satisfies n/(n+T_{c}²)>x where T_{c} is the inverse cumulative t distribution with degrees of freedom n−1 for the given confidence levels.

Pattern A is a sub-pattern of B, if the pattern attribute set of B is a subset of pattern attribute set of A and all the conditions on pattern attributes of B holds on A too. In other words, A is a sub pattern of pattern B, if the record set of pattern A is a subset of record set of pattern B. B is a super-pattern of A.

Sub-pattern of A of pattern B is called a significant pattern if it has significantly high class probability for at least one class than pattern B. The significantly high class probability is done over a test where

$${p}_{sub \text{-} pattern} > {p}_{super \text{-} pattern} + {T}_{( 1 - s )} \sqrt{{p}_{super \text{-} pattern} ( 1 - {p}_{super \text{-} pattern} ) / n}$$

A pattern A is called a relevant pattern if the complement record set of the Pattern A from all its sub patterns, is still a reliable pattern. For example, if pattern A has a set of records r₁ to rₙ and pattern B1, B2, B3 created as an addition of attribute values of B on A etc. has a subset of records as {rₖ, . . . rₗ}, then the disjointed complement records of super pattern A is {r₁, . . . , rₖ₋₁, rₗ₊₁, . . . rₙ}. A pattern's statistical parameters are always adjusted to its complement record set of the pattern A.

Pattern A can be refinable pattern if a sub pattern B of A that is reliable, has a significantly higher class probability for at least one class can be found. This is possible when pattern A has a minimum frequency for at least one class to become a reliable pattern and if that class probability can be improved significantly through the test

$$1 < p + {T}_{c} \sqrt{\frac{p ( 1 - p )}{n}}$$

where p is the current class probability and n the frequency of that pattern.

All definitions recited herein are intended for educational purposes to aid the reader in understanding the principles of the invention and the concepts contributed by the inventor to furthering the art, and are to be construed as being without limitation to such specifically definitions.

### Mathematical Basis

This portion of the disclosure discusses the mathematical underpinnings of how many patterns need to be evaluated in order, reliable patterns, significant patterns, refinability, relevancy and low variability attributes.

In principle, a pattern is a subset of conditional attributes and an instance of a value-pair for those attributes. If a dataset has m conditional attributes and n as average attribute cardinality, the number of patterns that need to be evaluated goes up to (1+n)^{m}−1.

### a) Discretization

In mathematics, discretization concerns the process of transferring continuous values into discrete counterparts. This process is usually carried out as a first step toward making them suitable for numerical evaluation and implementation on digital computers. Such two discretization techniques which are supported in the system are uniform scaling into equal width bins or equal frequency bins. This can be done in a distributed way by using multiple computing buckets. However, the system supports any other discretization techniques as well. In order, to achieve best results with discretization, it is important to preserve the discernibility of the attribute. Techniques are available such as mutual information based discretization or through discernibility matrix in rough sets, which preserves the discernibility of the attributes. The system works even if no discretization is performed but loses patterns due to low frequencies of continuous data.

### b) Low Variability Attributes

At the pre-processing stage, the system checks whether an attribute has enough variability to distinguish different records. For example, if an attribute has only one possible value, that attribute will not be useful in generating interesting class patterns. Even if one value of an attribute highly dominates in the record set, then also it is not useful in generating class patterns. Such attributes will be removed from the dataset before the system starts finding patterns.

For each attribute in the attribute set of the dataset, the system can compute its variability and discernibility strength. Initially, the system assigns variability to 1 and the discernibility strength to zero for all attributes. The system updates for each attribute its variability to 0 and thus removes that attribute from further analysis, if the attribute taking its dominant value has a probability that has a confidence interval that contains 1 on one side at a given confidence level

$$1 < p + {T}_{c} \sqrt{\frac{p ( 1 - p )}{n}}$$

where p is the probability of the attribute taking its dominant value and n the number of records in the dataset

The discernibility strength is computed as follows. All the records in the data set are partitioned into groups so that all the records in a group have the same attribute value for that attribute. The system computes the class probability distribution for each partition. In each partition of records, the system takes out those classes, which have higher probabilities than in the entire dataset (effectively, the lift, the attribute value gives on the class probability over the entire attribute) and compute the discernibility strength as average increment of class probability of each record belonging to those classes. The attributes are then sorted in descending order of discernibility strength.

### c) Pattern Occurrence

Out of (1+n)^{m}−1, the patterns appear in the dataset are interesting, because the system can validate each of those patterns.

Each record in a dataset can generate 2^{m}−1 patterns from size 1 to size n. If the dataset has l records then l(2^{m}−1) patterns will be generated.

If two records have same values for some of the attributes, then some of the patterns generated by them are repeated. If a pattern is not repeated, statistically such pattern will not bring any conclusive understanding on new data. The system considers those patterns, which will repeatedly occur to analyze the data and get statistically conclusive understanding.

Hence, the system deals with less than l(2^{m}−1) patterns for analysis of data. In addition, a pattern may contain other patterns fully or wholly when extended. In other words, the patterns represent the same set of instances. These are also removed from analysis.

### d) Reliable Patterns

Class pattern is a reliable pattern if its estimated lowest value of the confidence interval of that class probability in the entire population of records is above the desired minimum probability. To explain the reliable pattern concept, a dataset, which contains observed instances (records) of a live system, does not consist of all possible instances that can occur. New instances may occur in future. Even if all the patterns of a given dataset are found, they can only explain instances in that dataset. But it is expected to find patterns in the entire possible instances. If all the patterns of a random sample data are found, it raises a question on how reliable the patterns will be on the entire population of records.

The system must find reliable statistical inferences to be made about the validity of any patterns discovered. The system uses some statistical tests to estimate the lowest probability with a desired confidence of each pattern produced based on available dataset if it is to be considered a pattern on the entire population of records. Pattern class probability for a particular class Expectations it is the lowest estimated class probability of the pattern for that class with a desired confidence.

In fact, the record set of each pattern in the dataset is a sample of record set of that pattern in the entire population. The system statistically analyzes each pattern in the entire population through these samples. The entire population is huge and regardless of its distribution, the system estimates the population parameters through samples. (Reference: Central limit theorem (CLT))

The system assumes that the number of records for each pattern in the dataset is small. So, the system uses T distribution to estimate pattern parameters of the record set of the entire population through these samples. In probability and statistics, T distribution is a member of a family of continuous probability distributions that arises when estimating the Expectation of a normally distributed population in situations where the sample size is small. T distribution almost behaves like normal distribution when the size of the sample is high.

If there is a sample of size n, collected from a population with class dₗ probability p, then the sample maximum class dₗ probability pₛ with confidence c is p+T_{c}\sqrt{p(1−p)/n} where T_{c} is the T distribution inverse cumulative probability value with n−1 degrees of freedom and confidence c.

When the system finds a sample record of a pattern, the system can then compute the class probabilities of that sample. If the system estimates population class probabilities with confidence c through this sample, it has to find out how conclusive they are in reality. In other words, the system needs to estimate minimum population class probabilities with confidence c by using this sample.

The system doesn't know how good of sample it has from the dataset to estimate the population class probabilities. To ensure calculation works even in the worst case, the system assumes the sample has maximum possible class probabilities with confidence c. Then population class probability can be computed for class dₗ as:

pₛ=p+T_{c}\sqrt{p(1−p)/n}.

By solving this equation for p, system gets:

$$p = \frac{( 2 {p}_{s} + ( {T}_{c}^{2} / n ) ) - \sqrt{{( 2 {p}_{s} + ( {T}_{c}^{2} / n ) )}^{2} + 4 ( 1 + ( {T}_{c}^{2} / n ) ) {p}_{{s}^{2}}}}{2 ( 1 + ( {T}_{c}^{2} / n ) )}$$

The estimated minimum population class dₗ probability will be more than p with confidence c.

As n becomes larger then p will be equal to pₛ.

If the estimated minimum population class dₗ probability is to be more than x, it has to satisfy p>x.

Suppose sample class dₗ probability is 1 then pₛ=p+T_{c}\sqrt{p(1−p)/n} can be re-written as 1=p+T_{c}\sqrt{p(1−p)/n} and by solving for p, the equation results in:

p=n/(n+T_{c}²) and p>x implies n/(n+T_{c}²)>x.

If the system has a sample of record set of a pattern with class dₗ probability 1, it has to satisfy n/(n+T_{c}²)>x to have estimated minimum population class dₗ probability x with confidence c. Therefore even if a sample has class dₗ probability 1 with n/(n+T_{c}²)≤x, the system cannot conclusively calculate that the estimated minimum population class dₗ probability will be more than x. Therefore, if a pattern to be an interesting pattern for class dₗ with estimated minimum population class dₗ probability x with confidence c, then it's class frequency to be of minimum n which satisfies n/(n+T_{c}²)>x.

For each class in the dataset, an interesting class pattern should have estimated population minimum class dₗ probability more than x, which is set at the time of defining interesting class pattern for each dataset and class.

A pattern to be a reliable pattern, it's class frequency n should satisfy n/(n+T_{c}²)>x. Any sub pattern will have lesser class frequencies than the super pattern. So, if a pattern is not meeting minimum class frequency, any refinement of the pattern also doesn't meet minimum class frequency.

The system can stop generating refined patterns for patterns if all its class frequencies nₗ, satisfies nₗ/(nₗ+T_{c}²)≤x.

### e) Refinable Patterns

Pattern A can be refinable pattern if a sub pattern B of A that is reliable has a significantly higher class probability for at least one class can be found.

Mathematically, if the pattern class dₗ frequency is n, which should be above the minimum frequency, then any sample of size n of the pattern can be significantly different with respect to class dₗ only if sample probability for class dₗ,
pₛₐₘₚₗₑ>p+T₍₁₋ₛ₎\sqrt{p(1−p)/n} where s is significance parameter.
The maximum possible value for pₛₐₘₚₗₑ is 1 and if

$$1 < p + {T}_{c} \sqrt{\frac{p ( 1 - p )}{n}} ,$$

then no significantly different with respect to class dₖ can be found.

Hence, the system can stop generating all those sub patterns with probability

$$1 < p + {T}_{c} \sqrt{\frac{p ( l - P )}{n}} .$$

Hence, the system can stop generating further sub-patterns for patterns if all its class probabilities satisfy pₛ≤p+T_{c}\sqrt{p(1−p)/nₗ} where nₗ is the class dₗ frequency of the pattern.

### f) Significant Patterns

Sub-pattern of A of pattern B is called a significant pattern if it has significantly high class probability for pattern class than pattern B. The significantly high class probability is done over a test where

$${p}_{sub \text{-} pattern} > {p}_{super \text{-} pattern} + {T}_{( 1 - s )} \sqrt{{p}_{super \text{-} pattern} ( 1 - {p}_{super \text{-} pattern} ) / n} .$$

For the purpose of minimizing the number of comparisons, the sub-pattern of size k is compared with the reliable super-patterns of size k−1. The system for each reliable pattern, stores the highest probability amongst itself and its super-patterns. Therefore, a comparison with reliable patterns of size k−1 compares the sub-pattern effectively with all its super-patterns.

### System Implementation

A computing bucket is a processing unit. Any computing infrastructure which has a processor and a memory can be the computing bucket provided it meets the minimum processing and memory capabilities. Each computing bucket receives a set of data and computes the intended output and shares it with other computing buckets.

The system contains multiple such computing buckets with one of them being set as a centralized bucket or master computing bucket. The compute bucket can be set up on a given IT infrastructure using available cluster management tools. A centralized system assigns the computing tasks and resources to different computing buckets and coordinates and organizes the resources available with the computing buckets appropriately.

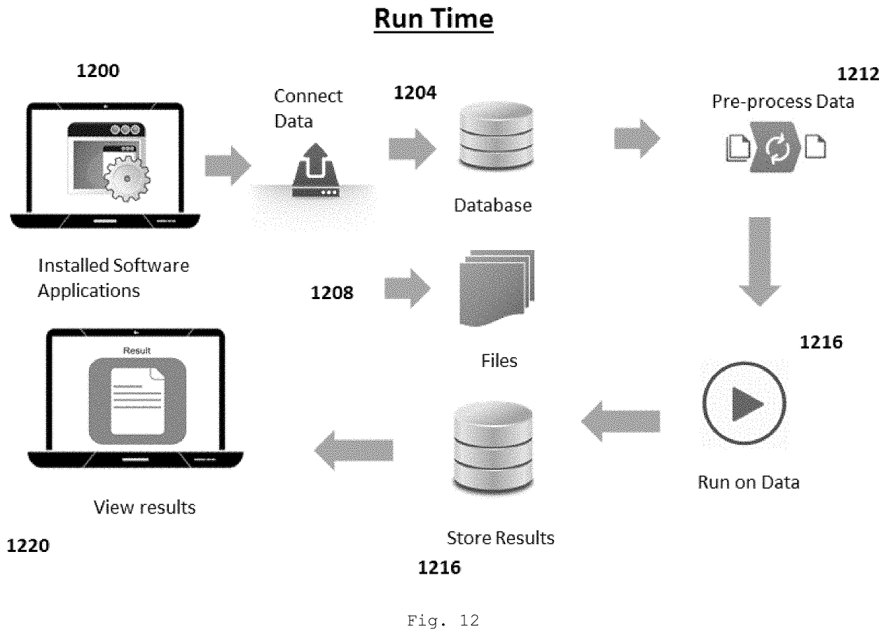

FIG. 12 shows the computer implemented view 1200 of the process to extract patterns. The system connects to the database or files 1204 and loads the data to process into the database 1208 and files on the system. The system pre-processes this data 1212. The system runs the extraction of patterns by running the data 1216. Finally, the system stores the results into the database 1220 and displays the results 1224.

### Computing Statistics Required to Discretize the Continuous Attributes and the Class Distribution in the Data Set

In mathematics, discretization concerns the process of transferring continuous values into discrete counterparts. This process is usually carried out as a first step toward making them suitable for numerical evaluation and implementation on digital computers. Such two discretization techniques which are supported in the system are uniform scaling into equal width bins or equal frequency bins. However, the system supports any other discretization techniques as well. In order, to achieve best results with discretization, it is important to preserve the discernibility of the attribute. Techniques are available such as mutual information based discretization or through discernibility matrix in rough sets, which preserves the discernibility of the attributes. The system works even if no discretization is performed but loses patterns due to low frequencies of continuous data.

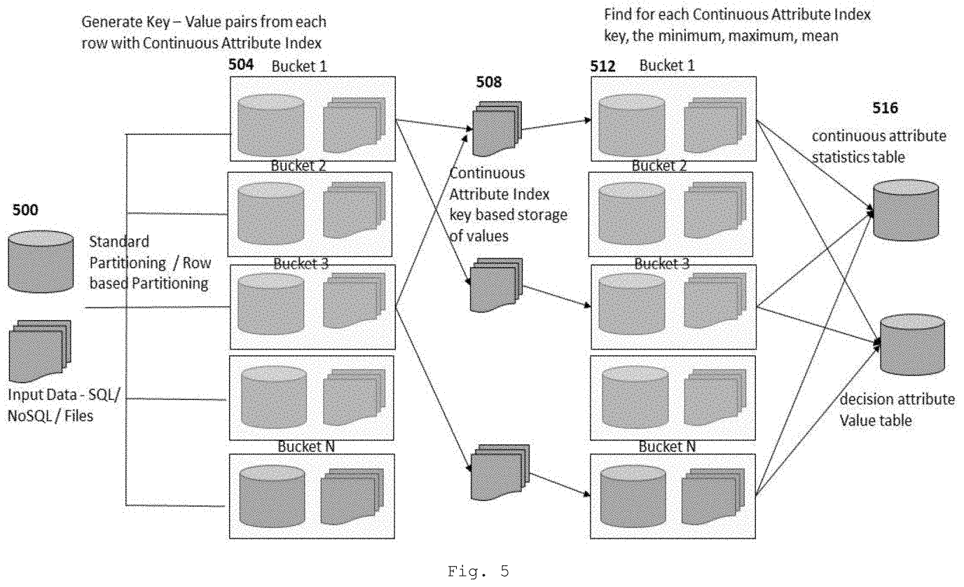

There are parallel methods available to discretize the continuous attributes. However, we give here the two parallel discretization methods the system can use for uniform scaling into equal width bins or equal frequency bins. FIG. 5 shows the high level process for discretizing the dataset. Initially, the system will be provided the dataset in which each record is having all the conditional attribute values in specified order and at the end having the decision attribute value. In other words, the dataset will be in the form of a table where each column represents an Attribute Value of each record and each row represents a record (observed instance). Each record in the dataset should have a unique id. If not, the system generates a unique id for each record by using available standard techniques. The system also be provides the index of each attribute in the record, the type of attribute in the form of a Boolean value true for continuous and false for non continuous and the number of discrete values after discretization. To discretize the attributes, the system, uses the following Data Structures and Tables.

### Data Structures:

Continuous Attribute: (Attribute Name, Attribute Column Index in the table format of record dataset, Minimum, Maximum, Expectation, Expectation of Squares and Standard deviation)
Class distribution hash map: Holds the (Class, Frequency) pairs.

### Tables:

Class Distribution Map

| Class (Row Key) | Frequency | Probability |
|---|---|---|
| [symbol] | [symbol] | [symbol] |

[symbol]

indicates data missing or illegible when filed

Continuous Attribute Statistics

| Attribute | | | | | |
|---|---|---|---|---|---|
| Index | | | | Expectation | Standard |
| (Row Key) | Minimum | Maximum | Expectation | of Squares | Deviation |
| [symbol] | [symbol] | [symbol] | [symbol] | [symbol] | [symbol] |

[symbol]

indicates data missing or illegible when filed

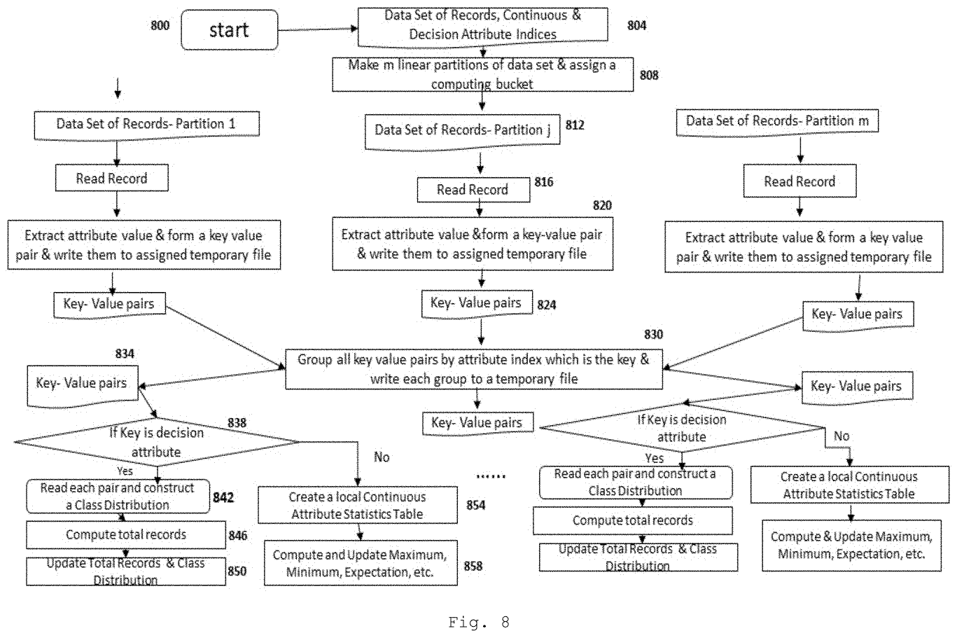

FIG. 8 shows a detailed parallel processing for computing class distribution and statistics of continuous attributes. Initially 800, the system will be provided attribute names or column indices of attributes in the dataset, and type of the attribute (continuous or discrete). The system generates a continuous attribute statistics table 804, 854. The system does a row based partition of the data in to smaller sets using any standard partitioning technique 500, 808. Then the system assigns each partition of data to an available computing bucket to process in parallel further 504, 812.

Each value of a decision attribute represents a unique class in the dataset. After that, the computing bucket forms a key (decision attribute index) and value (decision attribute value) pair 508, 834 and sends them to a computing bucket which computes the class frequencies and class probabilities for each class 512 by updating a class distribution hash map with the key being decision attribute value and the value being the frequency of that decision attribute value in the dataset on receiving each new key value pair. Then the computing bucket creates a table Class Distribution Map and updates the table 520, 842.

An example class distribution hash map is below:

| Class (d₁) | Frequency of Class (d₁) |
|---|---|
| 1 | 700 |
| 0 | 9300 |

An example class distribution map table is below:

| | Frequency of | Probability |
|---|---|---|
| Class (d₁) | Class (d₁) | of Class (d₁) |
| 1 | 700 | 0.07 |
| 0 | 9300 | 0.93 |

The computing bucket from the same records that it received and for each continuous attribute forms a key (attribute index) and value (attribute value) pair 820 and sends them to different computing buckets 824. The pairs which have the same key will be sent to the same bucket. The system determines which key value pairs to be received by which computing bucket for further computing 830. If enough computing buckets are not available, the system writes the key value pairs to the external storage in the retrievable form and whenever computing buckets are available, the system retrieves these key value pairs and sends to an available computing bucket.

At the beginning, the computing buckets construct an object of Continuous Attribute for each key by initially assigning the value zero for frequency, minimum, maximum, expectation, expectation of squares and standard deviation 854. Then the computing bucket updates these values as it receives the key value pairs 516. Whenever it receives a key value pair, the computing bucket checks whether the received value is less than the minimum, if yes, it will replace the minimum with the received value 858. The computing bucket performs same calculation for the maximum. The computing bucket calculates the expectation using ((expectation*frequency)+received value)/(frequency+1). The computing bucket performs similar calculation for the expectation of squares. Finally, it increments the frequency for the key. Once the computing bucket exhausts all the key value pairs it receives, it computes the standard deviation by the formula

$$\sqrt{expectation of squares - {( expectation )}^{2}}$$

and it stores the Continuous Attribute values to the table Continuous Attribute Statistics.

In the case of uniform scaling discretization method, the system takes each continuous attribute and computes the discrete intervals from the maximum and minimum of the attribute values. In the case of uniform frequency discretization method, the system takes each continuous attribute and computes discrete intervals from the expectation and standard deviation using the Gaussian distribution.

### g) Computing the Significant Class Probabilities to be Reliable Significant Relevant Class Pattern

The system will be provided all the required input variables such as Minimum Probability, Confidence, Significance, number of discrete intervals for continuous attributes. The system computes the total number of records in the data set 846 by summing up the class frequencies from the table Class Distribution Map.

The system computes the required minimum class probability a pattern should have to be a significant class pattern for each class. These probabilities should be more than the required Minimum Probability and the estimated class probability for that class in the entire data set. The estimated class probability is the lower bound of the confidence interval of the population probability for that class at the given confidence levels from the class pattern for that class. Based on this probability, the system computes the required minimum class frequency a pattern should have to be a significant class pattern for each class. The system keeps all these values in a shared memory where each computing bucket can access them.

### Pseudo Code:

Input: Dataset of records, Attribute Indices and type (continuous or discrete), the number of available computing buckets m.

### Process at Master Computing Bucket

1) Create a continuous attribute statistics table CAST.
2) Create a Class Distribution Table CDT
3) Create a list of keys to hold all keys along with a pointer to a temporary file for each key in which all values of that key are to be stored
4) Make row based m partitions of the dataset of records
5) Assign each partition and a new temporary file to a computing bucket to process to generate key, value pairs
6) initiate computing buckets
7) For each temporary files written by computing buckets
   a) Read key value pair
   b) If key is already added to the list of keys
      i) Write the value in the temporary file pointed by the key
   c) Else
      i) Create a temporary file and add the key to the list of keys and point the key to the created temporary file
      ii) Write the value in the temporary file for which the key points to
8) if computing buckets (assigned to generate key value pairs from records) exhaust generating key value pairs
   a) Sort all the keys
   b) For each key
   c) Assign the temporary file pointed by the key to an available computing bucket to compute class frequency and probability and continuous attribute statistics depending upon the key
   d) Initiate computing buckets
      Process at Computing Bucket, which Generate Key Value Pairs:
1) For each record in the assigned partitioned dataset
   a) Read record
   b) Extract Decision Attribute Index and Decision Attribute Value
   c) Write Decision Attribute Index and Decision Attribute Value pair to the temporary file, which is assigned and accessed by the master computing bucket.
   d) For each Continuous Attribute in the data set
      i) Extract Continuous Attribute Index and Continuous Attribute Value
      ii) Write Continuous Attribute Index and Continuous Attribute Value pair to the temporary file, which is assigned by the master computing bucket.
         Process at Computing Bucket, which Computes Class Frequency and Probability or Continuous Attribute Statistics
         (Note: Each computing bucket is assigned a partition set of key value pairs with same key. Key will be an Attribute Index and value is the Attribute value).
1) Receive the key and the partition of key, value pairs from master computing bucket
2) If key is Decision Attribute Index
   a) Create a class distribution hash map for that key
   b) For each value dᵢ
      i) If (dᵢ exists in the class distribution hash map)
         (1) Update class distribution hash map by increasing the frequency of that value by 1.
      ii) Else
         (1) Update class distribution hash map by adding that value with frequency 1.
3) Create a variable TN representing total number of values in the data set.
4) For each entry in the class distribution hash map
   a) Update Class Distribution Table CDT by writing the decision value (key of the hash map), the frequency (value of the hashmap).
   b) TN=TN+ the frequency (value of the hashmap).
   c) For each entry in the Class Distribution Table CDT
      i) Update probability with frequency/TN
5) Else
   a) Create a Continuous Attribute object for that key.
   b) Update the Continuous Attribute by assign the value zero for frequency, minimum, maximum, expectation, expectation of squares and standard deviation.
   c) For each continuous value cᵢ
   d) If cᵢ is less than the minimum,
      i) Replace the minimum with the received value cᵢ.
   e) If cᵢ is greater than the maximum,
      i) Replace the maximum with the received value cᵢ.
   f) Update the expectation as (expectation*frequency+cᵢ)/(frequency+1)
   g) Update the expectation of squares as (expectation of squares*frequency+cᵢ²)/(frequency+1).
   h) Increment the frequency by adding 1.
6) If the computing bucket exhausts reading all the values from the assigned partition
   a) Compute and update the standard deviation as

$$\sqrt{expectation of squares - {( expectation )}^{2}}$$

7) Update Continuous Attribute values in table Continuous Attribute Statistics CAST for the Attribute Index, which is same as received key.

### i) Finding Refinable Patterns of Size 1

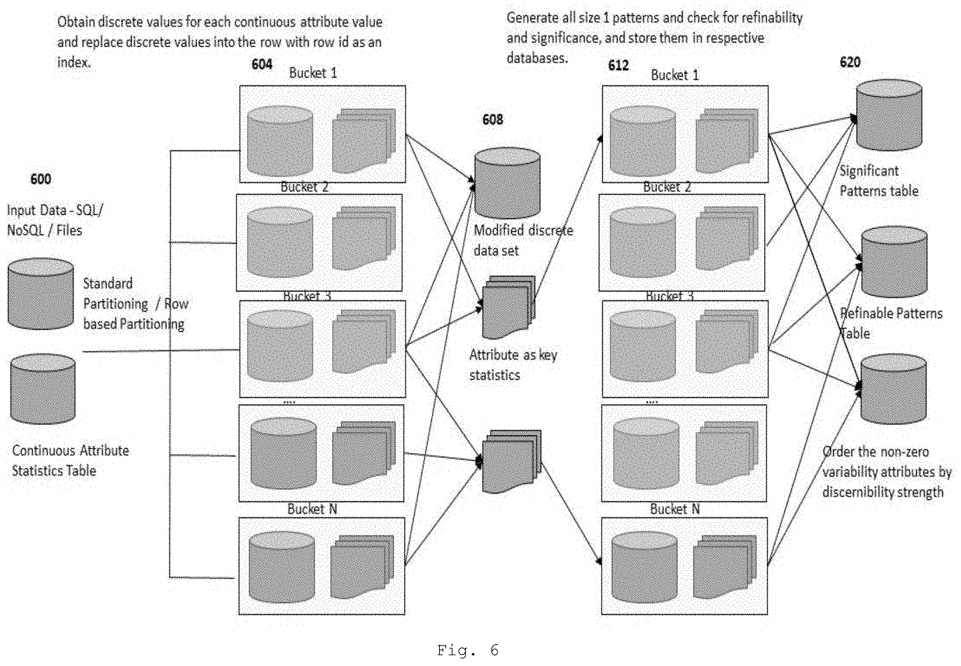

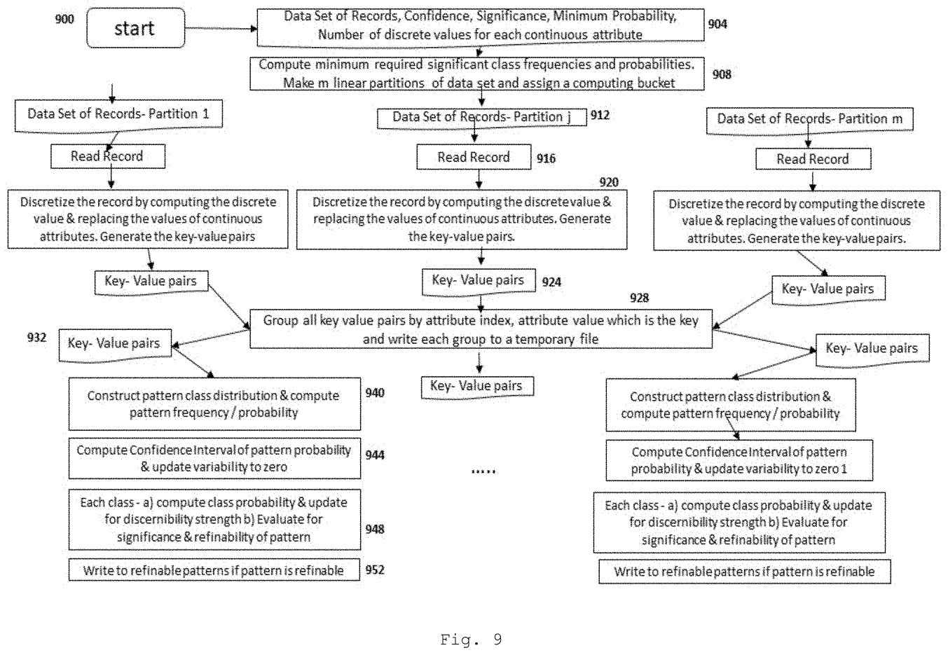

FIG. 6 shows the high level process for the discretizing the record set and finding the refinable patterns for size 1. FIG. 9 show a detailed parallel processing for finding the refinable patterns for size 1. In this step, the system discretizes 604 each continuous value 600 and stores the new records in a table 608 based on the chosen discretization method. The system generates size 1 patterns 612 and checks whether they are refinable, and if refinable the system computes the required minimum frequency the refined pattern should have for each class, and the required minimum probability the refined pattern should have for each class to be a significant pattern of that class 620. The system computes attribute variability and discernibility strength of each attribute. The system removes all refinable patterns of size 1 from the list of refinable patterns of size to generate size 2 patterns.

For each attribute in the attribute set of the dataset, statistically one can estimate the variability and discernibility strength as follows. Initially, the system assigns variability to 1 and the discernibility strength to zero for all attributes. The system updates for each attribute its variability to 0 and thus removes that attribute from further analysis, if the attribute taking its dominant value has a probability that has a confidence interval that contains 1 on one side at a given confidence level

$$1 < p + {T}_{c} \sqrt{\frac{p ( 1 - P )}{n}}$$

where p is the probability of the attribute taking its dominant value and n the number of records in the dataset.

(The confidence interval of the probability that the attribute takes the dominant value contains 1 means that the attribute has no information at all in discerning records in to different classes.)

The discernibility strength is computed as follows.

For each attribute, the system computes the class probability distribution for each of its values. For each attribute value, the system takes out those classes, which have higher probabilities than in the entire dataset (effectively, the lift, the attribute value gives on the class probability over the entire attribute) and computes the discernibility strength as average increment of class probability of each record belonging to those classes. The attributes are then sorted in descending order of discernibility strength.

The system uses the following Data Structures and Tables in this step.

### Data Structures:

### RecordSet: ArrayListWritable(ArrayListWritable of LongWritable)

### PatternKeyWritable: (Attribute Set (ArrayListWritable of IntWritable), Value Set (ArrayListWritable of Text)).

### SignificantPatternKeyWritable: (Attribute Set (ArrayListWritable of IntWritable), Value Set (ArrayListWritable of Text), Class (Text)).

Pattern Class distribution hash map: Holds the (Class, Frequency) pairs.
Minimum Required Pattern Frequency hash map: Holds the (Class, Minimum Required Pattern Frequency) pairs.
Minimum Required Refined Pattern Frequency hash map: Holds the (Class, Minimum Required Refined Pattern Frequency) pairs.
Minimum Required Significant Probability hash map: Holds the (Class, Minimum Required Significant Probability) pairs.

### AttributeCharacterWritable: (Attribute Index, Variability, Discernibility Strength)

### Tables:

### Discretized Record Set:

| | | | | |
|---|---|---|---|---|
| Record ID | Condition | Condition | Condition | Decision |
| (Row Key) | Attribute 1 | Attribute 2 | Attribute n | Attribute |

Condition Attribute Character Table

| | | |
|---|---|---|
| Condition Attribute Index | Variability | Discernibility |
| (Integer) (Row Key) | (Boolean) | (Double) |

Attribute Discernibility Rank Table

| | |
|---|---|
| Condition Attribute Index | Discernibility |
| (Integer) (Row Key) | Rank (Integer) |

Significant Patterns

| | | | | | | | |
|---|---|---|---|---|---|---|---|
| Significant | | | | | Pattern | Pattern | Pattern |
| Pattern Key | Pattern | Pattern | Class | Class | Record | Record | Record |
| (Row Key) | Frequency | Probability | Frequency | Probability | Set1 | Set2 | Set m |

### Refinable Patterns:

| | | | | | | | |
|---|---|---|---|---|---|---|---|
| | | | Required Min. | Required Min. | | | |
| | | | Refined | Significant | | | |
| Pattern | | | Pattern Class | Pattern Class | Pattern | Pattern | Pattern |
| Key | Pattern | Pattern | Frequency | Probability | Record | Record | Record |
| (Row Key) | Frequency | Probability | Table | Table | Set1 | Set2 | Set m |

Required Minimum Refined Pattern Class Frequency Table

| | |
|---|---|
| Class | Required minimum refinable |
| | frequency |

Requried Minimum Significant Pattern Class Probability Table

| | |
|---|---|
| Class | Required minimum significant |
| | probability |

FIG. 9 shows the pre-processing step and the computation of size 1 significant and refinable patterns. In this step, the system generates Discretized Record Set Table, Condition Attribute Character Table, Attribute Discernibility Rank Table, Refinable Patterns of Size 1 and Significant Patterns tables 904.

Initially, the system computes the required minimum pattern class frequencies and the required minimum significant pattern class probabilities for each pattern to be searched in the data set.

The required minimum class frequency nᵢ for each class dᵢ in the dataset to make a pattern reliable should satisfy nᵢ/(nᵢ+T_{c}²)≤x where T is the T-inverse cumulative distribution with nᵢ−1 degrees of freedom. Here x is the desired minimum probability. Initially, the system assigns value 2 for nᵢ and then it increments nᵢ until it satisfies nᵢ/(nᵢ+T_{c}²)≤x. The significant probability for each class dᵢ in the dataset computed as the maximum of class dᵢ probability in the data set and the desired minimum probability.

The system does a row based partition of the data set in to smaller sets 908. Then the system assigns each partition of data to an available computing bucket to process in parallel further. The computing bucket takes each record 912, 916, and for each condition attribute, forms a key, value pair.

Each pattern is identified with a unique key, which is represented with a PatternKeyWritable structure. PatternKeyWritable structure has two members attribute set and value set. Attribute set is an array of IntWritables. Value set is an array of Text. (IntWritable and Text are data structures which are equivalent to integer and string with serialisation property.) To keep pattern key structure same for all sizes patterns, we are using key as PatternKeyWritable for size 1 patterns though the respective attribute set and value set are having single elements.

The computing bucket takes each record, and for each condition attribute forms a key 920, value pair. The key will be a PatternKeyWritable. The attribute set of this key will be an array of IntWritable which consists of a single element, the index of the condition attribute. The value set of this key will be an array of Text which consists a single element namely, the corresponding value of the condition attribute in that record. The value of the key, value pair will be the combination of the decision attribute value in that record and unique id of that record.

Each key will represent a pattern in the data set. Computing bucket writes all these key value pairs 924 to a temporary file. The system sorts all these key value pairs, groups them by key and assigns those groups to different computing buckets for further processing 928.

### Example

Sample Record set: Online Bank Transaction Data

| Record | Authentication | | IPUsed | |
|---|---|---|---|---|
| Id | Level | OTP | Known | Truth-Fraud |
| 1 | 2 | 1 | 1 | 1 |
| 2 | 2 | 1 | 1 | 0 |
| 3 | 2 | 1 | 0 | 0 |
| 4 | 2 | 1 | 1 | 0 |
| 5 | 1 | 1 | 0 | 0 |
| 6 | 3 | 1 | 1 | 0 |
| 7 | 3 | 0 | 0 | 0 |
| 8 | 2 | 1 | 1 | 0 |
| 9 | 2 | 1 | 1 | 0 |
| 10 | 2 | 1 | 1 | 0 |
| 11 | 3 | 1 | 1 | 0 |
| 12 | 3 | 1 | 1 | 0 |
| 13 | 2 | 1 | 1 | 0 |
| 14 | 2 | 1 | 1 | 0 |
| 15 | 2 | 1 | 1 | 0 |
| 16 | 3 | 1 | 1 | 0 |
| 17 | 3 | 1 | 1 | 0 |
| 18 | 2 | 1 | 1 | 0 |
| 19 | 2 | 1 | 1 | 0 |
| 20 | 3 | 1 | 1 | 0 |
| 21 | 2 | 1 | 1 | 0 |
| 22 | 1 | 0 | 1 | 1 |
| 23 | 2 | 1 | 1 | 0 |
| 24 | 3 | 1 | 1 | 0 |
| 25 | 2 | 0 | 1 | 0 |
| 26 | 2 | 1 | 0 | 0 |
| 27 | 1 | 1 | 0 | 1 |
| 28 | 1 | 1 | 0 | 0 |
| 29 | 3 | 1 | 1 | 0 |
| 30 | 3 | 1 | 1 | 0 |

This is a sample dataset (Online Bank Transaction Data) on which the patterns are generated. This sample has thirty rows and each row represents a record with a unique key Record Id. It has three condition attributes (Authentication Level, OTP, IPUsed Known). It has a decision attribute Truth-Fraud. When the computing bucket receives the first row, it creates three key value pairs one each from three condition attributes.

From the condition attribute Authentication Level it creates a key value pair as follows.

Key: A PatternKeyWritable with attribute set {1} and Value set {2}. Here 1 is the index of the condition attribute Authentication Level and 2 is the value of the condition attribute Authentication Level in the first row.

Value: It is a Text “1, 1”. Here 1 (first one) is the decision attribute value and another 1 (second one) is the record Id of the first row.

Similarly, from the conditional attribute OTP, it generates following key value pair.

Key: A PatternKeyWritable with attribute set {2} and Value set {1}. Here 2 is the index of the condition attribute OTP and 1 is the value of the condition attribute in the first row.

Value: It is a Text “1, 1”. Here 1 (first one) is the decision attribute value and another 1 (second one) is the record Id of the first row.

Likewise in summary, from the sample dataset, the computing buckets in the system creates 30*3=90 key value pairs. The key value pairs generated from top 3 rows are listed in the following table.

A sample of 9 out of 90 Key Value Pairs generated from the records listed in the above table will be the following.

| Key | | Value | |
|---|---|---|---|
| Attribute set | Value set | Decision Attribute Value | Record ID |
| {1} | {2} | 1 | 1 |
| {2} | {1} | 1 | 1 |
| {3} | {1} | 1 | 1 |
| {1} | {2} | 0 | 2 |
| {2} | {1} | 0 | 2 |
| {3} | {1} | 0 | 2 |
| {1} | {2} | 0 | 3 |
| {2} | {1} | 0 | 3 |
| {3} | {0} | 0 | 3 |

The system sends all these key value pairs to different computing buckets for further processing. The pairs which have the same key will be sent to the same computing bucket.

Computing buckets constructs a Class distribution hash map for each key 932 it receives 940. The computing bucket also constructs a record set, which is an ArrayListWritable to store the record ids of the pattern. If the dataset is huge and if there is a chance that the internal memory of the computing bucket cannot store all those record id's of the pattern, then the computing bucket stores the record id's in chunks to an external memory (table) where it can access later once the computing pattern statistics is completed. In that case, the computing bucket needs to keep track the number of record ids stored in the internal memory and once the number exceeds the total memory size required to store them internally, it transfers that chunk of records to the external storage and makes the internally stored record set empty. Whenever the computing bucket uses an external storage to store the record set chunks, it will set up a flag to 1 to know whether it has used external memory.

### Computing Class Distribution Map

Whenever the computing bucket receives the key value pairs it updates the corresponding Class distribution hash map. Once the receiving key value pairs for each key are completed, the computing bucket computes the class frequencies and estimated class probabilities for each class from the class distribution hash map 940.

| Key | Class distrib. | | |
|---|---|---|---|
| (PatternkeyWritable) | hash map | | Record set (ArrayListWritable) |
| ({1}, {0}) | Class | Frequency | {22, 5, 27, 28} |
| | 0 | 2 | |
| | 1 | 2 | |
| ({1}, {2}) | Class | Frequency | {9, 8, 4, 3, 2, 23, 21, 19, 18, 1, |
| | 0 | 15 | 15, 14, 13, 26, 10, 25} |
| | 1 | 1 | |
| ({1}, {3}) | Class | Frequency | {11, 30, 6, 29, 12, 24, 17, |
| | 0 | 10 | 20, 7, 16} |
| | 1 | 0 | |
| ({2}, {0}) | Class | Frequency | {25, 22, 7} |
| | 0 | 2 | |
| | 1 | 1 | |
| ({2}, {1}) | Class | Frequency | {30, 23, 1, 12, 21, 28, 20, 19, |
| | 0 | 25 | 18, 11, 27, 17, 8, 16, 15, 14, 10, |
| | 1 | 2 | 26, 24, 6, 5, 4, 13, 3, 9, 29, 2} |
| ({3}, {0}) | Class | Frequency | {26, 27, 5, 3, 7, 28} |
| | 0 | 5 | |
| | 1 | 1 | |
| ({3}, {1}) | Class | Frequency | {30, 29, 25, 24, 23, 22, 21, 20, |
| | 0 | 22 | 19, 18, 17, 16, 14, 13, 12, 11, |
| | 1 | 2 | 10, 9, 8, 6, 4, 2, 1, 15} |

### Updating the Attribute Variability

The computing bucket also computes the frequency of each key or frequency of each pattern it receives by summing up the class frequencies in the Class distribution hash map. This frequency is exactly equal to the frequency of that attribute value in the entire data set. The system computes the pattern probability by dividing this by the total number of records in the data set which the system has already computed and kept in the shared resources. Now the computing bucket computes the confidence interval of the pattern probability that is the probability that the attribute takes that particular attribute value in the data set. If the confidence of the probability of the pattern contains 1, then the computing bucket updates the variability of the attribute corresponding to the attribute index of the pattern to zero.

### Updating the Discernibility Strength

The computing bucket takes the class probability of each class in the class distribution hash map and checks whether that is more than the class probability in the entire dataset. If yes, it updates the Condition Attribute Character Table by adding the ratio of the (product of the positive difference in class probability and the class frequency (lift in class probabilities)) and (the total number of records in the dataset) to the existing discernibility strength value 948.

Example of Condition Attribute Character Table for the Fraud Data Set.

| Condition Attribute Index | Variability | Discernibility |
|---|---|---|
| (Integer) (Row Key) | (Boolean) | (Double) |
| 1 | TRUE | 0.1066666 |
| 2 | TRUE | 0.1066666 |
| 3 | TRUE | 0.0266666 |

Example of Attribute Discernibility Rank Table for the Fraud Data Set

| Condition Attribute Index | |
|---|---|
| (Integer) (Row Key) | Discernibility Rank |
| 1 | 1 |
| 2 | 2 |
| 3 | 3 |

### Evaluating for Significance and Refinability of Pattern

The computing bucket creates hash maps Required Minimum Refined Pattern Class Frequency and Required Minimum Significant Class Probability.

These hash maps are used to store the required minimum refined pattern class frequencies and the Required Minimum significant pattern class probabilities when the present pattern under consideration is refined.

For each class in the pattern class distribution hash map, the computing bucket checks whether the frequency is meeting the required minimum frequency. If yes, the computing bucket evaluates whether the received pattern is a significant pattern by checking whether the pattern has more than the minimum required probability and has significantly higher class probability than the corresponding class probability in the entire data set. If yes, it then stores the significant pattern with SignificantPatternKeyWritable structure as Row Key and pattern statistics and record ids as values in to the Significant Patterns table for that class 948. If the present pattern is significant, then the computing bucket checks whether the confidence interval of the present pattern class probability has 1 in it 944, if not it computes the minimum frequency required to the refined pattern to have significantly higher class probability than the present significant pattern and updates the hash map Required Minimum Refined Pattern Class Frequency.

It also updates the hash map Required Minimum Significant Class Probability with the present pattern class probability. If the received pattern is not a significant pattern, the computing bucket updates the hash map Required Minimum Refined Pattern Class Frequency with the required minimum class frequency. Also updates the Required Minimum Significant Class Probability with the required minimum class probability.

Once the computing bucket exhausts checking all the classes for the pattern significance and refinability, then it checks whether the hash map Required Minimum Refined Pattern Class Frequency is empty, if not, it stores the pattern in to the Refinable Patterns Table with Pattern Key as row key along with other values as pattern frequency, pattern probability, Required Minimum Refined Pattern Class Frequencies, Required Minimum Significant Pattern Class Probabilities. The computing bucket stores the array of record ids to the table to the same row key. If the computing bucket uses the external storage to store record ids, then it transfers them to the table one chunk at a time and references the same row key but in to different column cells.

### Example of Refinable Patterns of Size 1 of Fraud Data Set

| | | | | | Expected Min. | | |
|---|---|---|---|---|---|---|---|
| | | | Expected Min. | | Significant | | |
| | | | Refined | | Pattern Class | | |
| Pattern | | | Pattern Class | | Probability | | |
| Key | Pattern | Pattern | Freq. Table | | Table | | Pattern |
| (Row Key) | Frequency | Probability | Class | Freq. | Class | Prob. | Record Set |
| [1]_[2]: | 16 | 0.53333 | 0 | 2 | 0 | 0.9 | 9, 8, 4, 3, 2, 23, |
| | | | | | | | 21, 19, 18, 1, 15, |
| | | | | | | | 14, 13, 26, 10, 25 |
| [2]_[1] | 27 | 0.9 | 0 | 2 | 0 | 0.9 | 30, 23, 1, 12, 21, |
| | | | | | | | 28, 20, 19, 18, 11, |
| | | | | | | | 27, 17, 8, 16, 15, |
| | | | | | | | 14, 10, 26, 24, 6, 5, |
| | | | | | | | 4, 13, 3, 9, 29, 2 |
| [3]_[0] | 6 | 0.2 | 0 | 2 | 0 | 0.9 | 26, 27, 5, 3, 7, 28 |
| [3]_[1] | 24 | 0.8 | 0 | 2 | 0 | 0.9 | 30, 29, 25, 24, 23, |
| | | | | | | | 22, 21, 20, 19, 18, |
| | | | | | | | 17, 16, 14, 13, 12, |
| | | | | | | | 11, 10, 9, 8, 6, 4, |
| | | | | | | | 2, 1, 15 |

Example of Significant Patterns Generated at this Stage

| Significant | | Pattern | | | Pattern |
|---|---|---|---|---|---|
| Pattern Key | Pattern | Prob- | Class | Class | Record |
| (Row Key) | Frequency | ability | Frequency | Probability | Setl |
| [1]_[3]_0 | 10 | 0.3333 | 10 | 1 | {11, 30, |
| | | | | | 6, 29, 12, |
| | | | | | 24, 17, |
| | | | | | 20, 7, 161 |

Below are the results after the finding the size 1 patterns step:
computing the discernibility strength and attribute variability of each attribute
rank all the attributes with non zero variability according to their discernibility strength and keep available in shared memory
find all reliable significant patterns of size 1
find refinable patterns of size 1

### Pseudo Code:

Input: Dataset of records, Attribute Indices and types (continuous or discrete), Discretizing method, the number of available computing buckets m, Required levels of confidence, significance and minimum probability of searching patterns, Total number of records TN

### Process at Master Computing Bucket

1. Create Attribute Characteristics Table ACT to store variability and discernibility strength of each attribute in the data set
2. Create Discretized Data Table DDT to store each record after replacing continuous values with corresponding discretized values for all continuous attributes.
3. Create a Table Refinable Patterns of Size 1 RP1T.
4. Create a Table Significant Patterns SPT
5. Create a Table Attribute Rank Table ART
6. Create a Minimum Required Pattern Frequency hash map
7. For each class dᵢ in the Class Distribution Table CDT
   a. Assign minimum required pattern frequency nᵢ=2
   b. While (nᵢ/(nᵢ+T_{c}²)≤min probability)
      i. nᵢ=nᵢ+1;
   c. Update Minimum Required Pattern Frequency for class dᵢ by nᵢ.
8. Make Minimum Required Pattern Frequency hash map available to all nodes by keeping it in shared memory
9. Create a list of keys (to be generated by computing buckets after the master computing bucket assigns partitioned data sets to them) to hold all keys along with a pointer for each key to a temporary file in which all values of that key are to be stored
10. Make m partitions of the dataset of records
11. Assign each partition and a temporary file for a computing bucket to process to generate key, value pairs
12. Initiate Computing Buckets
13. For each temporary file written by computing buckets
   a. Read key value pairs
   b. If key is already added to the list of keys
      i. Write the value in the temporary file pointed by the key
   c. Else
      i. Create a temporary file and add the key to the list of keys and point the key to the created temporary file
      ii. Write the value in the temporary file for which the key points to
14. If computing buckets (assigned to generate key value pairs from records) exhaust generating key value pairs
   a. Sort all the keys
   b. For each key
   c. Assign the temporary file pointed by the key to an available computing bucket to compute variability and discernibility strength of attributes, significant and refinable patterns of size 1
   d. Initiate Computing Buckets
15. Create Attribute Discernibility Rank Table ADRT
16. If (all computing buckets complete the computing of variability and discernibility strength of attributes, significant and refinable patterns of size 1)
   a. Read all Attribute indices along with Variability and Discernibility
   b. Delete all Attribute indices with 0 variability.
   c. Sort all Attribute indices an decreasing order of discernibility strength
   d. Add all sorted attribute indices to the Attribute Discernibility Rank Table ADRT with rank and Attribute Index.
      Process at Computing Bucket, which Generates Key Value Pairs:
1. For each record in the assigned partitioned dataset
2. Read record
3. For each continuous attribute
   i. Compute corresponding discrete value according to the discretize method given as input and replace the continuous value with discrete value in the record. (Note: Pseudo code to compute corresponding discrete value according to the discretize method is given below separately)
4. Add the record to the Discretized Data Table DDT
5. For each Attribute A in the data set
   ii. Create a new PatternKeyWritable PKW Object with empty Attribute set and empty Value set
   iii. Add Attribute A index to the Attribute Set of PKW
   iv. Add Attribute A value in the record to the Value Set of PKW
   v. Extract the record id and the decision attribute value
   vi. Form a key value pair with key as PKW and value as the combination of record id and the decision attribute value and write them to the temporary file assigned and accessed by the master computing node.
      Process at Computing Bucket, which Computes Refinable Patterns of Size 1, Significant Patterns of Size 1, Variability and Discernibility of Attributes
      (Note: Each computing bucket is assigned a partition set of key value pairs with same key. Key is a PatternKeyWritable and value is the combination of decision attribute and the value be the record id. Here Attribute set of the key is a singleton set with a single attribute index.)
1. Receive the key and the corresponding group of values from master computing bucket
2. Create a Pattern Class Distribution hash map for that key
3. Create a Record Set for that key
4. Create a Boolean variable IsRefinable and assign value false
5. Create a Required Minimum Refined Pattern Frequency hash map
6. Create a Required Minimum Significant Probability hash map
7. For each value
   a. Extract the decision value dᵢ (received as part of the value)
   b. If (dᵢ exists in the Pattern Class Distribution hash map)
      i. Update Pattern Class Distribution hash map by increasing the frequency of that value by 1.
   c. Else
      ii. Update Pattern Class Distribution hash map by adding that value with frequency 1.
   d. Extract the record id and add it to the Record Set.
8. Compute the Pattern Frequency PF by following loop
9. For each entry in the class distribution hash map
   b. PF=PF+ the frequency (value of the hash, map).
10. Compute Pattern probability by dividing the Pattern Frequency by the total number of records which is equal to (PatternFrequency/TN).
11. If (Confidence interval of the pattern probability contains 1)
   a. Update variability for the attribute index=0 in the Attribute Characteristics Table ACT
12. For each class dᵢ in Pattern Class Distribution hash map
   a. Compute Pattern Class dᵢ probability pᵢ by dividing the Pattern Class dᵢ Frequency by the Pattern Frequency PF
   b. If (Class Frequency>=minimum required pattern frequency for class dᵢ)
      i. Compute the Estimated Class Probability epᵢ for class dᵢ
      ii. If (epᵢ is greater than the minimum probability and class dᵢ probability in the data set)
         1. If (epᵢ is significantly higher than the class dᵢ probability in the data set)
            a. Add Pattern to the Significant Patterns Table SPT with SignificantPatternKey(Combination of Pattern Attribute Set, Pattern Value Set and the class), Pattern Frequency, Pattern Probability, Class dᵢ frequency, Class dᵢ Probability and Record Set.
            b. If (Class Probability dᵢ is less than 1)
            i. Compute the Significant Probability spᵢ for epᵢ which is higher end value of its confidence interval of epᵢ.
            ii. If (spᵢ is less than 1)
            1. IsRefinable=true
            2. Create and Assign Required Minimum Refined Pattern Frequency nᵢ=Minimum Required Pattern Frequency of dᵢ.
            3. While (nᵢ/(nᵢ+T_{c}²)≤spᵢ)
            a. nᵢ=nᵢ+1;
            4. Update Required Minimum Refined Pattern Frequency for class dᵢ by ni.
            5. Update Required Minimum Significant Probability for class di by epᵢ.
         2. Else
            a. IsRefinable=true
            b. Update Required Minimum Refined Pattern Frequency for class dᵢ by Minimum Required Pattern Frequency of dᵢ.
            c. Update Required Minimum Significant Probability for class di by maximum of class probability dᵢ in the data set and minimum probability.
   c. Else
      i. IsRefinable=true
      ii. Update Required Minimum Refined Pattern Frequency for class dᵢ by Minimum Required Pattern Frequency of dᵢ.
      iii. Update Required Minimum Significant Probability for class di by maximum of class probability dᵢ in the data set and minimum probability.
   d. If (Pattern Class dᵢ probability pᵢ>class dᵢ probability in the data set)
      i. Create a variable discernibility_strength and assign value 0.
      ii. discernibility_strength=discernibility_strength
      iii. +(class_probability−classdistbn.get(label.getKey( )))*patternfrequency
      iv. /TotalNoOfRecords;
   e. If (variability for the attribute index extracted from the key in the Attribute Characteristics Table ACT is non zero)
      i. Update discernibility strength of the attribute index extracted from the key in the Attribute Characteristics Table ACT by adding discernibility_strength to it.
   f. If (isRefinable=true)
      i. Add Pattern to the Refinable Patterns of size 1 RP1T with PatternKey(Combination of Pattern Attribute Set, Pattern Value Set), Pattern Frequency, Pattern Probability, Required Minimum Refined Pattern Frequencies for refinable classes, Required Minimum Significant Probabilities for refinable classes and Record Set.

### Pseudo Code to Compute Corresponding Discrete Value for a Value of Continuous Attribute

Input: value, Attribute statistics, and discretization method, number of discrete values n
1. If discretization method=uniform scaling
   a. Discrete value=Round of (value−Attribute minimum value)*numOfDiscreteClasses/(Attribute maximum value−Attribute minimum value)
2. If discretization method=uniform frequency
   a. Compute Standard Normal Value SNV for value by the formula (value−Attribute Expectation)/Attribute Standard Deviation
3. Compute Cumulative Normal Probability less than SNV
4. if (Cumulative Normal Probability<0.15)
   a. Discrete value=−1;
5. Else
   a. If Cumulative Normal Probability>99.85)
      i. Discrete value=n;
   b. Else
      i. Discrete value=Round of ((Cumulative Probability−0.15)*numOfDiscreteClasses/99.7))

### j) Finding Size k Reliable Significant Patterns

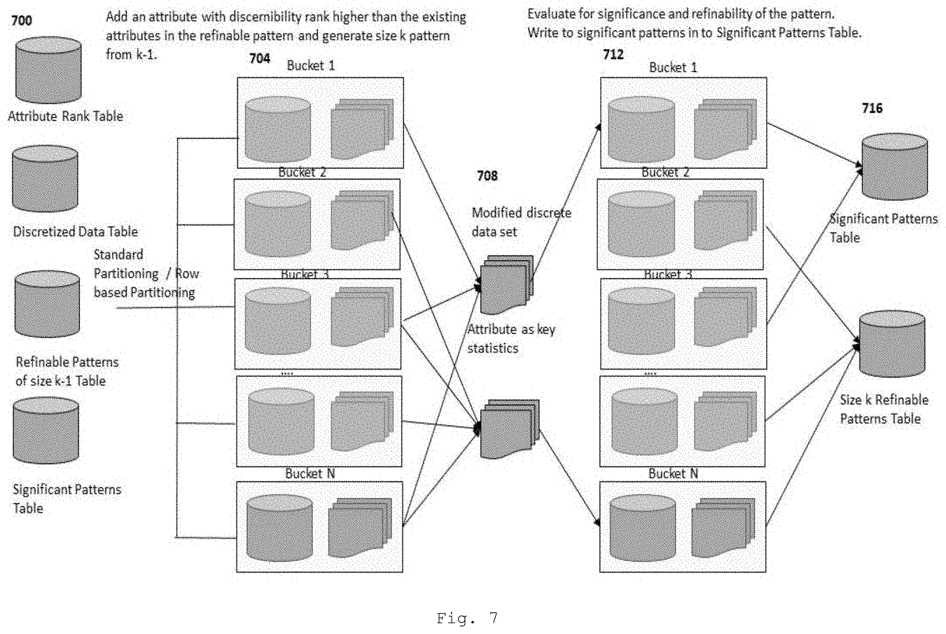

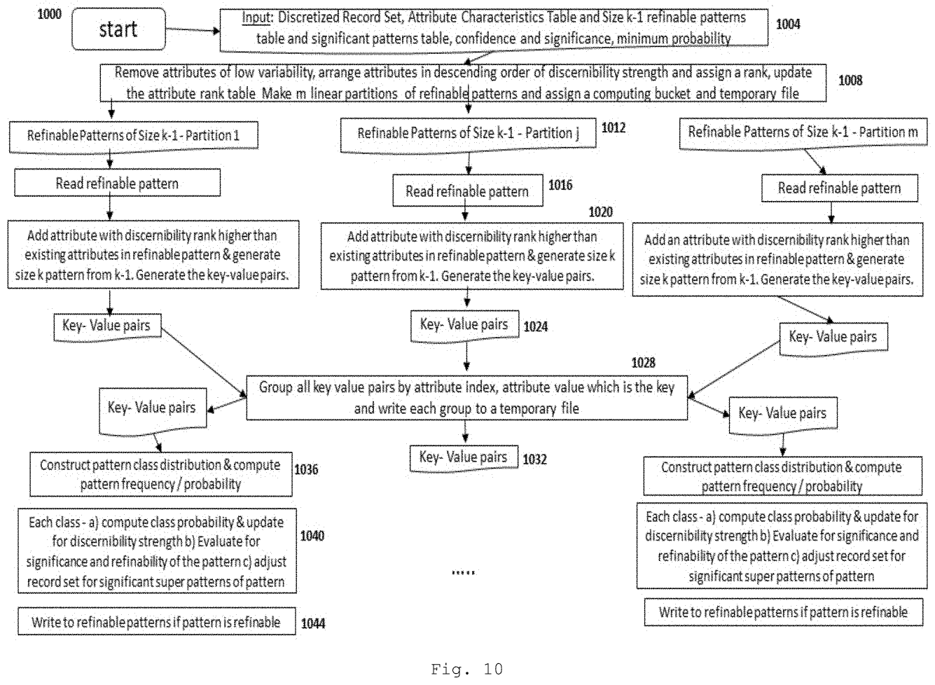

In these iterations, size k patterns are generated from the size k−1 refinable patterns as follows. FIG. 7 shows the high level process for finding the size k reliable significant patterns. The table Refinable Patterns of size k−1 consists all patterns which have scope to be refined further along with required minimum class frequencies, required minimum class probabilities to be significantly improved patterns and the set of pattern records. The set of pattern records will have same attribute value for each attribute in Attribute Set of the pattern. To refine this pattern, we need to add one more attribute from the complement set of attributes of present refinable pattern's Attribute Set to itself and the corresponding attribute value to the attribute Value Set of the pattern. FIG. 10 shows the detailed parallel processing for computing size k significant and refinable patterns from size k−1 refinable patterns.

This is equivalent to the same process of generating size 1 patterns on the set of records of the present refinable pattern with the complement set of attributes of present refinable pattern Attribute Set. Now these patterns will have their pattern Attribute Set, and Value Set will be of size k. To avoid generating the same patterns multiple times, the system refines the refinable patterns by adding only those attributes having lower or equal discernibility strength than all attributes in the Attribute Set of the present refinable pattern.

The system uses the following Data Structures and Tables in this step.

### Data Structures

### RecordSet: ArrayListWritable(ArrayListWritable of LongWritable)

### PatternKeyWritable: (Attribute Set (ArrayListWritable of IntWritable), Value Set (ArrayListWritable of Text)).

### SignificantPatternKeyWritable: (Attribute Set (ArrayListWritable of IntWritable), Value Set (ArrayListWritable of Text), Class (Text)).

Pattern Class distribution hash map: Holds the (Class, Frequency) pairs.
Required Minimum Refined Pattern Frequency hash map: Holds the (Class, Required Minimum Refined Pattern Frequency) pairs.
Required Minimum Significant Probability hash map: Holds the (Class, Required Minimum Significant Probability) pairs.
Class distribution hash map: pairs of (Class, Frequency)

### Tables:

### Discretized Record Set

### Attribute Discernibility Rank Table

### Significant Patterns

### Refinable Patterns

### Required Minimum Refined Pattern Class Frequency Table

### Required Minimum Significant Pattern Class Probability Table

The system does a row based partitions of the table Refinable Patterns of Size k−1 in to smaller tables 700, 1008. Then the system assigns each partition of data to an available computing bucket to process in parallel further. The computing bucket takes each record 1012, 1016 from one of the partition of the table Refinable Patterns of Size k−1 and generates new patterns by adding a new attribute which has lower or equal discernibility strength than the attributes in the present pattern Attribute Set 704, 1020. The computing bucket receives the pattern key which is PatternKeyWritable and its record sets in chunks stored in separate columns along with Pattern key. The computing bucket takes each PatternKeyWritable and for each of its records generates new key value pairs by adding to its Attribute Set each attribute which has discernibility strength less than or equal to the lowest discernibility strength of all the attributes in pattern combination of PatternKeyWritable and the same attribute's value to the Value Set to form a new key. The value for this key is the combination of the decision attribute value in that record and unique id of that record. Each key will represent a new sub pattern in the data set. The computing bucket writes all these key value pairs to a temporary file 708, 1024. The system sorts all these key value pairs, groups them by key and assigns those groups to different computing buckets for further processing 1028.

### Example

Sample Record set: Online Bank Transaction Data (Table given in section i)

Order of attributes in discernibility strength

| ATTRIBUTE INDEX | DISCERNIBILITY RANK |
|---|---|
| IN DATA SET | OF THE ATTRIBUTE |
| 1 | 1 |
| 2 | 2 |
| 3 | 3 |

Sample of Refinable Patterns of size 1.

| | | Min | | Minimum | | |
|---|---|---|---|---|---|---|
| Key | | required | | required | | |
| Attribute | Value | frequencies | | Probabilities | | |
| Set | Set | 1 | 0 | 1 | 0 | Record set |
| {1} | {2} | — | 2 | — | 0.9 | 9, 8, 4, 3, 2, 23, |
| | | | | | | 21, 19, 18, 1, 15, |
| | | | | | | 14, 13, 26, 10, 25 |
| {2} | {1} | — | 2 | — | 0.9 | 30.23, 1, 12, 21, |
| | | | | | | 28, 20, 19, 18, 11, |
| | | | | | | 27, 17, 8, 16, 15, |
| | | | | | | 14, 10, 26, 6, 5, 4, |
| | | | | | | 13, 3, 9, 29, 2 |
| {3} | {0} | — | 2 | — | 0.9 | 26, 27, 5, 3, 7, 28 |
| {3} | {1} | — | 2 | — | 0.9 | 30, 29, 25, 24, 23, |
| | | | | | | 22, 21, 20, 19, 18, |
| | | | | | | 17, 16, 13, 13, 12, |
| | | | | | | 11, 10, 9, 8, 6,4, 2, |
| | | | | | | 1, 15 |

Sample of new pattern key value pairs of size 2 patterns which are PatternKeyWritables (pair of attribute set and value set) generated from Refinable Patterns of size 1.

| | | Value | |
|---|---|---|---|
| Key | | Decision | Record |
| Attribute Set | Value Set | Attribute Value | ID |
| {1, 2} | {2, 1} | 0 | 9 |
| {1, 3} | {2, 1} | 0 | 9 |
| {1, 2} | {2, 1} | 0 | 8 |
| {1, 3} | {2, 1} | 0 | 8 |
| {1, 2} | {2, 1} | 0 | 4 |
| {1, 3} | {2, 1} | 0 | 4 |
| {1, 2} | {2, 1} | 0 | 3 |
| {1, 3} | {2, 0} | 0 | 3 |
| {1, 3} | {2, 1} | 1 | 1 |
| {1, 2} | {2, 1} | 1 | 1 |

The computing bucket starts reading the key and the set of values attached to it. First it takes the key and forms all possible k−1 super pattern keys 712 by removing one attribute and its value at a time from the received key and checks whether they are present in the refinable patterns of size k−1.

Example: For Pattern Key ({2,4,5},{a,b,c}), the super pattern keys are ({4,5},{b,c}), ({2,5},{a,c}) and ({2, 4}, {a,b}).

While checking their presence in the size k−1 refinable patterns, the computing bucket computes the minimum of frequencies of all its super patterns. For each class, the computing bucket also computes the required minimum refined pattern class frequency the refined pattern should have in order to be a further refinable pattern, which is the maximum of required minimum class frequencies of all its refinable super-patterns.

The computing bucket also computes the required minimum significant pattern class probability the refined pattern should have in order to be a significantly refined pattern which is the maximum of required minimum class probabilities of all its refinable super-patterns. Even if one super pattern key is not present in the size k−1 refinable patterns, the computing bucket stops evaluating the newly formed pattern for significance and refinability. If all super pattern keys are present in the size k−1 patterns then the Computing bucket constructs a Class distribution hash map for that key. The computing bucket also constructs a record set which is an ArrayListWritable to store the record ids of the pattern. If the dataset is huge and if there is chance that the internal memory of the computing bucket cannot store all those record id's of the pattern, then the computing bucket stores the record id's in chunks to an external memory (table) where it can access later once the computing pattern statistics is completed 716. In that case the computing bucket needs to keep track the number of record ids stored in the internal memory and once the number exceeds the total memory size required to store them internally, it transfers that chunk of records to the external storage and makes the internally stored record set empty. Whenever the computing bucket uses an external storage to store the record set chunks, it will set up a flag to 1.

As the computing bucket reads each value, it updates the corresponding Class distribution hash map. Once the receiving values is completed the computing bucket computes the class frequencies and the pattern frequency. Then it checks whether the pattern frequency is equal to the minimum of frequencies of all its super patterns and if yes, the computing bucket stops evaluating the newly formed pattern for significance and refinability. If not the computing bucket creates hash maps of Required Minimum Refined Pattern Class Frequency and Required Minimum Significant Class Probability.

These hash maps are used to store the Required Minimum refined pattern class frequencies and the Required Minimum significant pattern class probabilities when the present pattern under consideration is refined.

For each class in the pattern class distribution hash map, the computing bucket checks whether the frequency is meeting the required minimum refinable pattern frequency computed earlier. If yes, the computing bucket evaluates whether the received pattern is a significant pattern by checking whether the pattern has significantly higher class probability than the minimum required significant pattern probability computed earlier 1040. If yes, it then stores the significant pattern with SignificantPatternKeyWritable as Row Key and pattern statistics and record ids as values in to the Significant Patterns table for that class and adjust each of its super significant patterns by removing the common records for the present pattern and its super pattern from the super pattern in Super Pattern Table. To get all possible super significant patterns, the computing bucket takes the pattern key and removes one at a time an existing attribute index and the value of the same attribute from the Attribute set and Value Set accordingly. Then it checks whether those significant patterns exist in the Significant Patterns Table and if yes, remove all the records from it which are in the present pattern. If that does not exist in the Significant Patterns Table, it further finds its super patterns by removing one more attribute and its value from the super pattern and checks whether that exists in the Significant Patterns Table. If yes remove all the records from it which are to the present pattern. It continues until there are no super patterns that can be found.

If the present pattern is significant, then the computing bucket checks whether the confidence interval of the present pattern class probability has 1 in it, if not it computes the minimum frequency required to the refined pattern to have significantly higher class probability than the present significant pattern and updates the hash map Required Minimum Refined Pattern Class Frequency.

It also updates the hash map Required Minimum Significant Class Probability with the present pattern class probability 1044.

If the received pattern is not a significant pattern, the computing bucket updates the hash map Required Minimum Refined Pattern Class Frequency with the required minimum class frequency. Also updates the Required Minimum Significant Class Probability with the required minimum class probability

Once the computing bucket exhausts checking all the classes for the pattern significance and refinability, then it checks whether the hash map Required Minimum Refined Pattern Class Frequency is empty, if not, it stores the pattern in to the Refinable Patterns Table with Pattern Key as row key along with other values as pattern frequency, pattern probability, Required Minimum Refined Pattern Class Frequencies, Required Minimum Significant Pattern Class Probabilities.

### Example of Refinable Patterns of Size 2 of Fraud Data Set

| | | | Expected Min. | | Expected Min. | | |
|---|---|---|---|---|---|---|---|
| | | | Refined | | Significant | | |
| Pattern | | | Pattern Class | | Pattern Class | | Pattern |
| Key | Pattern | Pattern | Freq. Table | | Prob. Table | | Record |
| (Row Key) | Frequency | Probability | Class | Freq. | Class | Prob. | Set |
| [1,2]_[2,1]: | 15 | 0.5 | 0 | 2 | 0 | 0.9 | 18, 8, 4, 3, 2, 23, |
| | | | | | | | 21, 19, 1, 15, 14, |
| | | | | | | | 13, 26, 10, 9 |
| [1,3]_[2,1] | 14 | 0.4667 | 0 | 2 | 0 | 0.9 | 10, 25, 13, 14, 15, |
| | | | | | | | 1, 18, 19, 21, 23, 2, |
| | | | | | | | 4, 8, 9 |
| [2,3]_[1,0] | 5 | 0.1667 | 0 | 2 | 0 | 0.9 | 26, 27, 5, 3, 7, 28 |
| [2,3]_[1,1] | 22 | 0.7333 | 0 | 2 | 0 | 0.9 | 30, 29, 25, 24, 23, |
| | | | | | | | 22, 21, 20, 19, 18, |
| | | | | | | | 17, 16, 14, 13, 12, |
| | | | | | | | 11, 10, 9, 8, 6, 4, |
| | | | | | | | 2, 1, 15 |

Example of Significant Patterns Generated at this Stage

| Significant | Pattern | Pattern | Class | Class | |
|---|---|---|---|---|---|
| Pattern Key | Fre- | Prob- | Fre- | Prob- | Pattern Record |
| (Row Key) | quency | ability | quency | ability | Set1 |
| [1]_[3]_0 | 10 | 0.3333 | 10 | 1 | {11, 30, 6, 29, 12, |
| | | | | | 24, 17, 20, 7, 16} |
| [2, 3]_[1, 1]_0 | 22 | 0.7333 | 21 | 0.9545 | {30, 29, 25, 24, 23, |
| | | | | | 22, 21, 20, 19, 18, |
| | | | | | 17, 16, 14, 13, 12, |
| | | | | | 11, 10, 9, 8, 6, 4, |
| | | | | | 2, 1, 15} |

### Pseudo Code:

Input: Discretized Data Table DDT (Data Set), Attribute Discernibility Rank Table ADRT, Refinable Patterns of Size k−1 RF(k−1)T, Significant Patterns Table SPT, The number of available computing buckets m, Required levels confidence, significance and minimum probability of searching patterns, Total number of records.

### Process at Master Computing Bucket

1. Create a Table Refinable Patterns of Size k RPkT.
2. Create a list of keys (to be generated by computing buckets after the master computing bucket assigns partitioned data sets to them) to hold all keys along with a pointer for each key to a temporary file in which all values of that key are to be stored
3. Make row based m partitions of Refinable Patterns of Size k−1 PR(k−1)T
4. Assign each partition and a new temporary file for a computing bucket to process to generate key, value pairs
5. Initiate Computing Buckets
6. For each temporary file created by computing buckets
   a. Read key value pairs
   b. If key is already added to the list of keys
      i. Write the value in the temporary file pointed by the key
   c. Else
      i. Create a temporary file and add the key to the list of keys and point the key to the created temporary file
      ii. Write the value in the temporary file for which the key points to
7. If computing buckets (assigned to generate key value pairs from records) exhaust generating key value pairs
   a. Sort all the keys
   b. For each key
   c. Assign the temporary file pointed by the key to an available computing bucket to compute significant and refinable patterns of size k
   d. Initiate Computing Buckets
      Process at Computing Bucket, which Generate Key Value Pairs:
1. For each record in the assigned partitioned dataset
   a. Read record
   b. Extract PatternKey and PatternRecordSet
   c. Extract Attribute Set and Value Set from PatternKey
   d. For each Attribute A having high discernibility rank than the discernibility rank of the last attribute index in the Attribute Set
      i. Add Index of Attribute A to the Attribute Set
      ii. For each record id in the PatternRecordSet
         1. Get the value of the Attribute A in the record and add it to the Value Set
         2. Form a new PatternKeyWritable PKW with Attribute Set and Value Set
         3. Extract the record id and the decision attribute value
         4. Form a key value pair with key as PKW and value as the combination of record id and the decision attribute value and write them to the temporary file assigned by the master computing node.
      iii. Remove A from Attribute Set and and value of Attribute A from Value Set
         Process at Computing Bucket which Computes Refinable Patterns of Size k−1, Significant Patterns of Size k−1
         (Note: Each computing bucket is assigned a partition set of key value pairs with same key. Key is a PatternKeyWritable and value is the combination of decision attribute and the value be the record id)
1. Receive the key and the partition of key, value pairs from master computing bucket
2. Create a Pattern Class Distribution hash map for that key
3. Create a Record Set for that key
4. Create a Boolean variable IsRefinable and assign value false
5. Create a Required Minimum Refined Pattern Frequency hash map
6. Create a Required Minimum Significant Probability hash map
7. Create an Required Minimum Refined Pattern Frequency hash map
8. Create an Required Minimum Significant Probability hash map
9. Create a variable Flag and assign 0.
10. Create a variable MinimumFrequencyofSuperPattern and assign value 0
11. For each Attribute index i in the Attribute Set of key PKW
   a. Form a Super Pattern key (SPKW) by removing i
   b. If SPKW not in the Table RP(k−1)T
      i. Flag=1
      ii. Break
   c. Else
      i. If MinimumFrequencyofSuperPattern is greater than SPKW Frequency
         1. MinimumFrequencyofSuperPattern=SPKW Frequency
      ii. For each class dᵢ in Class Distribution Table
         1. If Required Minimum Refined Pattern Frequency contains dᵢ
            a. Update Required Minimum Refined Pattern Frequency of class dᵢ by maximum of Required Minimum Refined Pattern Frequency of dᵢ SPKW and existing value
            b. Update Required Minimum Significant Pattern Probability of class dᵢ by maximum of Required Minimum Significant Pattern Probability of dᵢ of SPKW and existing value
         2. Else
            a. Add dᵢ to the Required Minimum Refined Pattern Frequency hash map with value Required Minimum Refined Pattern Frequency of dᵢ of SPKW
            b. Add dᵢ to the Required Minimum Significant Pattern Probability hash map with value Required Minimum Significant Pattern Probability of dᵢ of SPEW
12. If Flag is equal to 1
   a. Break
13. For each value
   a. Extract the decision value dᵢ (received as part of the value)
   b. If (dᵢ exists in the Pattern Class Distribution hash map)
      i. Update Pattern Class Distribution hash map by increasing the frequency of that value.
   c. Else
      i. Update Pattern Class Distribution hash map by adding that value with frequency 1.
   d. Extract the record id and add it to the Record Set.
14. Compute the Pattern Frequency PF by following loop
15. For each entry in the class distribution hash map
   a. PF=PF+ the frequency (value of the hash, map).
16. If PF=SPKW Frequency
   a. Stop evaluating the pattern for refinability and significance.
17. Compute Pattern probability by dividing the Pattern Frequency by the total number of records which is equal to (PatternFrequency/TN).
18. For each class dᵢ in Pattern Class Distribution hash map
   a. If (Class Frequency>=Required Minimum Required Refined Pattern Frequency for class dᵢ)
      i. Compute Pattern Class dᵢ probability pᵢ by dividing the Pattern Class dᵢ Frequency by the Pattern Frequency PF
      ii. Compute the Estimated Class Probability epᵢ for class dᵢ
      iii. If (epᵢ is greater than the Required Minimum Significant Probability for class di)
         1. If (epᵢ is significantly higher than the Required Minimum Significant Probability for class di)
            a. Add Pattern to the Significant Patterns Table SPT with SignificantPatternKey(Combination of Pattern Attribute Set, Pattern Value Set and the class), Pattern Frequency, Pattern Probability, Class dᵢ frequency, Class dᵢ Probability and Record Set.
            b. Adjust all Significant Super Patterns of newly added Significant Patterns in the Significant Pattern Table
            (Note: This step will be explained more clearly later as a separate pseudocode.)
            c. If (Class Probability dᵢ is less than 1)
            i. Compute the Significant Probability spᵢ for epᵢ which is higher end value of its confidence interval of epᵢ.
            ii. If (spᵢ is less than 1)
            1. IsRefinable=true
            2. Create and Assign Required Minimum Required Refined Pattern Frequency nᵢ=Required Minimum Required Refined Pattern Frequency of dᵢ.
            3. While (nᵢ)/(nᵢ+T_{c}²)≤spᵢ)
            a. nᵢ=nᵢ+1;
            4. Update Required Minimum Required Refined Pattern Frequency for class dᵢ by nᵢ.
            5. Update Required Minimum Significant Probability for class di by epᵢ.
         2. Else
            a. IsRefinable=true
            b. Update Required Minimum Required Refined Pattern Frequency for class dᵢ by Required Minimum Required Refined Pattern Frequency of dᵢ.
            c. Update Required Minimum Significant Probability for class di by Required Minimum Significant Probability for class di.
   b. Else
      i. IsRefinable=true
      ii. Update Required Minimum Required Refined Pattern Frequency for class dᵢ by Required Minimum Required Refined Pattern Frequency of dᵢ.
      iii. Update Required Minimum Significant Probability for class di by Required Minimum Significant Probability for class di.
19. If (isRefinable=true)
   a. Add Pattern to the Refinable Patterns of size 1 RP1T with PatternKey(Combination of Pattern Attribute Set, Pattern Value Set), Pattern Frequency, Pattern Probability, Required Minimum Required Refined Pattern Frequencies for refinable classes, Required Minimum Significant Probabilities for refinable classes and Record Set.

### Pseudo Code:

### Adjust all Significant Super Patterns of Newly Added Significant Patterns in the Significant Pattern Table

### Input: Significant Pattern Key (SignificantPatternKeyWritable PKW), Record Set (ArrayListWritable<LongWritable>RS)

### Method: Adjust all Significant Super Patterns (Significant Pattern Key (SignificantPatternKeyWritable PKW), Record Set (ArrayListWritable<LongWritable>RS):

1. Extract AttributeSet AS, ValueSet VS and Class D from Significant Pattern Key PKW
2. For each Attribute Index j in AS
   a. Remove j from AS and value vⱼ of Attribute with index j from Value Set VS and keep j and vⱼ in temporary variables
   b. Form new Significant Pattern Key (NPKW) with AS, RS and D
   c. If (NPKW exists in Significant Patterns table SPT)
      i. Remove common record id's for PKW and NPKW from NPKW
   d. Else
      i. If (Attribute Set NAS of NPKW size >1)
         1. Adjust all Significant Super Patterns (NPKW, RS):
   e. Put back j in to AS and vⱼ in to VS
      k) Finding Relevant Patterns and Sorting them in the Order of Class, High Probability Low Pattern Size and High Frequency.

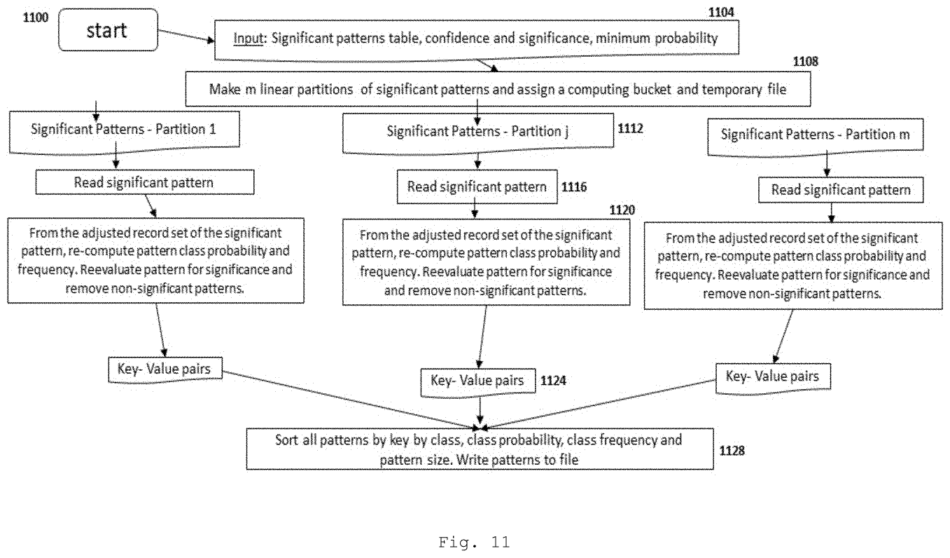

As described in the previous section j, once a relevant significant sub pattern is found, the computing buckets update the significant super patterns by removing the common records for both super and sub patterns. In the presence of significant sub patterns, a super pattern will be relevant only if it is still a significant pattern with the updated record set. FIG. 11 shows parallel processing for computing reliable, relevant and significant patterns.

The system does a row based partitions of the table Significant Patterns of Size k−1 in to smaller tables 1008. Then the system assigns each partition of data to an available computing bucket to process in parallel further. The computing bucket takes each significant pattern 1112 from one of the partition of the table Significant Patterns and computes the pattern relevant frequency, pattern relevant probability, class relevant frequencies and relevant estimated class probabilities from the existing record set of that significant pattern 1120. For significant class of that pattern, the computing bucket checks whether that is more than minimum required probability and significantly improved than its class probability in the entire population and if not, the computing bucket removes the significant pattern from the Significant Patterns table. If yes, the computing bucket updates the corresponding significant pattern in the Significant Patterns table with computed relevant values 1124.

Once this process of finding relevant significant patterns is completed, the system sorts the patterns in the order of class, high probability low pattern size and high frequency by using any standard parallel sorting procedures 1128.

### l) Finding the Cumulative Coverage of Records by the Sorted Class Patterns

### Pattern Output Statistics

The pattern output statistics are pattern frequency (number of times the pattern occurred in the training dataset), pattern class probability (the estimated probability of the class from the pattern on the entire data set), cumulative class coverage (the proportion of the class occurrences covered by the pattern in relation to the total occurrences of the class in the training dataset) and the cumulative class probability (the precision or positive prediction rate of all the patterns considered so far in the order of the sorted patterns.

### Example of Significant Patterns Generated at the End.

| Significant | Pattern | Pattern | Class | Class | |
|---|---|---|---|---|---|
| Pattern Key | Fre- | Prob- | Fre- | Prob- | Pattern |
| (Row Key) | quency | ability | quency | ability | Record Set1 |
| [1]_[3]_0 | 10 | 0.3333 | 10 | 1 | {11, 30, 6, 29, 12, |
| | | | | | 24, 17, 20, 7, 16} |
| [2, 3]_[1, 1]_0 | 22 | 0.7333 | 21 | 0.9545 | {30, 29, 25, 24, 23, |
| | | | | | 22, 21, 20, 19, 18, |
| | | | | | 17, 16, 14, 13, 12, |
| | | | | | 11, 10, 9, 8, 6, 4, |
| | | | | | 2, 1, 15} |

All examples and conditional language recited herein are intended for educational purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents hereof. Additionally, it is intended that such equivalents include both currently known equivalents as well as equivalents developed in the future, i.e., any elements developed that perform the same function, regardless of structure.

1. A computer implemented method for searching for patterns in datasets in a system having multiple computer processors comprising:
generating pattern key-value pairs from each discretized record of a dataset by taking an attribute and attribute value combination as a key and record identification (id) and decision value from computing buckets of said system;
writing key value pairs for each partition of records to temporary files via a computing bucket; and
sending key value pairs to different computing buckets in a sorted key order so that pairs with the same pattern key will be sent to the same computing bucket;

2. The computer implemented method of claim 1 further comprising:
calculating whether each pattern of size 1 extracted from the key value pairs is a reliable pattern for any class;
calculating whether a reliable pattern of size 1 is a significant pattern for any class if a class probability for such class is higher than the class probability for another class in said dataset;
calculating whether a pattern of size 1 is a refinable pattern where at least one class has a minimum frequency and does not have 1 as an upper end value of an estimated population probability confidence interval;
calculating a minimum significant probability for a refined pattern for each class for which the higher end value of a confidence interval of a class probability of the refinable pattern is a significant pattern;
calculating attribute variability and discernibility strength of each attribute; and
calculating a minimum refined pattern frequency for each class that has a class frequency that is higher than said minimum frequency and has a lower end of a confidence interval of a pattern class probability that is higher than a predetermined probability.

3. The computer implemented method of claim 2 further comprising:
making row based partitions of k−1 size patterns, where k is any value greater than or equal to 2;
from the partitions, generating size k key-value pairs from refinable patterns of size k−1 by adding one attribute and a value from the record set of size k−1 pattern in such a way that a discernibility index of such attribute is higher than an existing discernibility index of an attribute to the key and the updated record id and decision value as value;
writing key value pairs for each partition of records to temporary files via a computing bucket;
sending key value pairs to different computing buckets in a sorted key order so that pairs with same pattern key will be sent to the same computing bucket;
calculating pattern statistics for each pattern of size k;
evaluating whether super patterns of pattern of size k are refinable and computing a maximum significant probability of patterns that are refinable, and checking whether the frequency of a pattern is greater than a minimum frequency of the super patterns and whether the frequency of the size k pattern is greater than the maximum frequency for each class of the refinable super patterns; and
evaluating whether the pattern of size k has a probability not less than the minimum significant probability, and adding said pattern of size k to a significant pattern list if the pattern has a lower bound of a confidence interval of a pattern class probability that is higher than a class probability of reliable super-patterns of size k−1 of same class.

4. The computer implemented method of claim 3 further comprising:
readjusting pattern statistics for size k−1 super-patterns, where k is any value greater than or equal to 2 of the size k pattern;
updating a record set for each super-pattern of size k−1 of a size k pattern by removing record ids from a record id set of a super-pattern that occur in a size k pattern;
calculating whether a pattern of size k is a refinable pattern for any class where such class has a minimum frequency and does not have 1 as the upper end value of the estimated population probability confidence interval, and adding to the refinable patterns repository of size k;
calculating a minimum significant probability for the refined pattern for each class which has a higher end value of the confidence interval of that class probability if the refinable pattern is a significant pattern, otherwise determining that the minimum significant probability is the maximum of the higher end of the confidence interval of that class probability of significant super patterns of the refinable pattern; and
calculating a minimum refined pattern frequency for each class that has a class frequency that is higher than said minimum frequency and a lower end of a confidence interval of a pattern class probability is higher than the given probability.

5. The computer implemented method of claim 4 further comprising:
making a row based partitioning of the significant patterns;
re-evaluating the significant patterns for significance over the entire dataset by calculating the class probability of each class and adding a class to relevant patterns if found to be significant;
sorting relevant patterns based on descending order of probability and frequency and storing the sorted relevant patterns after generation of said relevant patterns; and
computing a cumulative coverage of the sorted relevant patterns by finding groups of records of that particular class;

6. The computer implemented method in claim 5 wherein in order to compute statistics to discretize continuous attributes and obtain a class distribution of a data set, further comprises:
making row based partitions of the dataset of records; building key value pairs from dataset records;
writing the key value pairs for each partition of records to temporary files;
sending the key value pairs in a sorted key order so that pairs with same attribute key will together; and
processing class frequency and probability values;
computing continuous attribute statistics of said dataset.

7. The computer implemented method of claim 5, wherein in order to determine said significant class probabilities to be reliably significant relevant class patterns for a data set, further comprises:
computing the minimum class probability for each class as the lower bound of a confidence interval of a population probability for that class at given confidence levels from the class pattern for that class;
computing the minimum class frequency as a pattern having a significant class pattern for each class; and
storing all these values in a shared memory for shared access.

8. The computer implemented method of claim 2, wherein said attribute variability and discernibility strength calculations of attributes further comprises:
finding a pattern probability of the patterns of the discretized data set;
updating the variability for the attribute index to zero if a confidence interval of the pattern probability has a value of 1; and
obtaining the pattern class distribution and computing the discernibility strength for each pattern as a weighted average improvement (positive lift) of class probabilities with pattern frequency as weights.

9. The computer implemented method of claim 8, further comprising removing size 1 significant and refinable patterns with zero variability attributes and sorting the attributes on the descending discernibility strength.

10. The computer implemented method of claim 6 wherein computing statistics to discretize continuous attributes and obtain class distributions in a data set further comprising:
making row based partitions of the dataset of records;
building key value pairs from data set records;
writing key value pairs for each partition of records to temporary files and extracting, key values comprising;
extracting a decision attribute index value as a key and decision attribute value;
writing the decision attribute index and a decision attribute value pair to a temporary file;
extracting a continuous attribute index value as a key and continuous attribute value;
writing the continuous attribute index and continuous attribute value pair to a temporary file;
sorting key value pairs in a sorted key order so that pairs with same attribute key will be together;
calculating a class frequency and a probability;
calculating continuous attribute statistics comprising:
updating a minimum value with a received attribute value if the minimum value is less than a predetermined minimum;
updating a maximum value with the received attribute value if the maximum value is greater than a predetermined maximum;
updating an expectation value;
updating an expectation of squares value by; and computing a standard deviation.

11. The computer implemented method of claim 6, wherein said discretization of continuous attributes further comprises:
making row based partitions of dataset of records
computing a range of an attribute as a maximum value minus a minimum value, and equally dividing the range into a number of discrete classes for uniform scaling discretization;
converting an attribute to a discrete value by using the difference of attribute value from an attribute minimum value in proportion to class width; and
writing the converted attribute set to a discretized table.
